(19) United States
(12) Patent Application Publication
(10) Pub. No.: US 2023/0043355 A1
(43) Pub. Date: Feb. 9, 2023

(54) BATTERY PACK AND VEHICLE INCLUDING THE SAME

(71) Applicant: LG ENERGY SOLUTION, LTD., Seoul (KR)

(72) Inventors: Jin-Yong PARK, Daejeon (KR); Jae-Min YOO, Daejeon (KR); Ho-June CHI, Daejeon (KR); Dal-Mo KANG, Daejeon (KR)

(21) Appl. No.: 17/880,441

(22) Filed: Aug. 3, 2022

(30) Foreign Application Priority Data
Aug. 4, 2021 (KR) 10-2021-0102791
Jun. 17, 2022 (KR) 10-2022-0074363
Aug. 3, 2022 (KR) 10-2022-0096836

(51) Int. Cl. H01M 50/211; H01M 50/183; H01M 50/308; H01M 10/42; H01M 10/655; H01M 50/533

(52) U.S. Cl. CPC H01M 50/211; H01M 50/183; H01M 50/308; H01M 10/425; H01M 10/655; H01M 50/533; H01M 2010/4271; H01M 2220/20

(57) ABSTRACT

A cell assembly includes a first sleeve. The first sleeve includes a first side, a second side facing the first side, and a third side connecting the first side and the second side. The sleeve also includes a first open end between the first side and the second side, a second open end between the first side and the second side, and opposite the first open end, and a third open end between the first open end and the second open end and opposite the third side. The cell assembly includes a first pouch-type cell between the first side and the second side of the first sleeve. A first surface of the first pouch-type cell is adjacent to the third open end. A second surface of the first pouch-type cell is opposite the first surface, and spaced apart from the third side of the first sleeve by a predetermined distance.

### CROSS-REFERENCE TO RELATED APPLICATIONS

This application claims the benefit of Korean Patent Application No. 10 - 2021 - 0102791 , filed on Aug. 4, 2021 , Korean Patent Application No. 10 - 2022 - 0074363 , filed on Jun. 17, 2022 , and Korean Patent Application No. 10 - 2022 - 0096836 , filed on Aug. 3, 2022 , the contents of which are all hereby incorporated by reference herein in their entirety. TECHNICAL FIELD

The present disclosure generally relates to the field of batteries, and more particularly, to a cell assembly, a battery pack, and a vehicle including the battery pack and methods of manufacturing the same. BACKGROUND ART

As technology development of and demand for various mobile devices, electric vehicles and energy storage systems (ESS) greatly increase, the interest and demand for secondary batteries as an energy source are rapidly increasing.

In general, secondary batteries are classified based on the shape of the battery. For example, a battery in which an electrode assembly is accommodated in a metal can is classified as a can-type battery, and a battery in which an electrode assembly is accommodated in a pouch is classified as a pouch-type battery. Generally, pouch-type batteries are vulnerable to external shock and are thus difficult to assemble with various other accompanying components. Accordingly, a battery pack utilizing pouch-type batteries requires a plurality of battery cells that are modularized into battery modules and then, the battery modules are accommodated in a pack case to assemble the battery pack. However, conventional battery modules require various components including, for example, a module case, in which a plurality of battery cells are stacked, a stacking frame made of a plastic material (e.g., a cartridge), plates provided at both ends in the cells' stacking direction, and various fastening members (e.g., bolts or other suitable fasteners). As such, potential for improving the energy density of a conventional battery pack is limited due to the accompanying components that are required for assembling a battery module. Therefore, there is a need for an efficient and cost effective solution to improve the energy density, cooling properties, and manufacturing processes of battery packs and vehicles including the same.

The present disclosure is directed to overcoming one or more of these challenges. The background description provided herein is for the purpose of generally presenting context of the disclosure. Unless otherwise indicated herein, the materials described in this section are not prior art to the claims in this application and are not admitted to be prior art, or suggestions of the prior art, by inclusion in this section. SUMMARY OF DISCLOSURE

According to certain aspects of the disclosure, a cell assembly, a battery pack, and a vehicle including the battery pack and methods of manufacturing the same for improving the energy density, cooling properties, and manufacturing processes are provided in this disclosure.

In one embodiment, a cell assembly may include a first sleeve. The first sleeve may comprise: a first side; a second side facing the first side; a third side connecting the first side and the second side; a first open end between the first side and the second side; a second open end between the first side and the second side, and opposite the first open end; and a third open end between the first open end and the second open end and opposite the third side. The cell assembly may further comprise a first pouch-type cell. The first pouch-type cell may be between the first side and the second side of the first sleeve. The first pouch-type cell may comprise a first electrode tab and a second electrode tab. A first surface of the first pouch-type cell may be adjacent to the third open end. A second surface of the first pouch-type cell may be opposite the first surface, and spaced apart from the third side of the first sleeve by a predetermined distance.

In another embodiment, a sleeve for a cell assembly may include: a first side; a second side facing the first side; a third side connecting the first side and the second side, the third side including a venting portion; a first open end between the first side and the second side; a second open end between the first side and the second side, and opposite the first open end; and a third open end between the first open end and the second open end, and opposite the third side. The sleeve may be configured to accommodate a pouch-type cell between the first side and the second side of the sleeve. The pouch-type cell may comprise a first electrode tab and a second electrode tab. A first surface of pouch-type cell may be adjacent to the third open end, and opposite the third side of the sleeve.

In yet another embodiment, a battery pack may include: a case having an inner surface; and a cell assembly on the inner surface. The cell assembly may include: a plurality of sleeves; and a pouch-type cell accommodated inside each of the plurality of sleeves. The pouch-type cell may include a first electrode tab and a second electrode tab. A first surface of the first pouch-type cell may be adjacent to the inner surface of the case. A second surface of the first pouch-type cell may be opposite the first surface, and spaced apart from at least one surface of each of the plurality of sleeves by a predetermined distance.

In yet another embodiment, a method of manufacturing a cell assembly may include providing a sleeve. The sleeve may include: a first side; a second side facing the first side; a third side connecting the first side and the second side; a first open end between the first side and the second side; a second open end between the first side and the second side, and opposite the first open end; and a third open end between the first open end and the second open end, and opposite the third side. The method of manufacturing the cell assembly may further include providing a pouch-type cell between the first side and the second side of the sleeve, the pouch-type cell comprising a first electrode tab and a second electrode tab. A first surface of the pouch-type cell may be adjacent to the third open end. A second surface of the pouch-type cell may be opposite the first surface, and spaced apart from the third side of the sleeve by a predetermined distance.

It is to be understood that both the foregoing general description and the following detailed description are exemplary and explanatory and are not restrictive of the disclosed embodiments, as claimed.

### BRIEF DESCRIPTION OF DRAWINGS

The accompanying drawings, which are incorporated in and constitute a part of this specification, illustrate various exemplary embodiments and together with the description, serve to explain the principles of the disclosed embodiments.

FIG. 1 is a schematic perspective view showing a battery pack according to an embodiment of the present disclosure from which some components are separated.

FIG. 2(a) is an exploded perspective view schematically showing a cell assembly having a pouch-type battery cell accommodated in a cell sleeve according to an embodiment of the present disclosure.

FIG. 2(b) is an exploded perspective view schematically showing a cell assembly having a plurality of pouch-type battery cell accommodated in a cell sleeve according to an embodiment of the present disclosure.

FIG. 3 is an exploded perspective view schematically showing a stacked configuration of a cell assembly having the pouch-type battery cell and the cell sleeve according to an embodiment of the present disclosure.

FIG. 4 is an exploded perspective view schematically showing a battery assembly according to an embodiment of the present disclosure.

FIG. 5 is an exploded perspective view schematically showing a battery assembly according to an embodiment of the present disclosure.

FIG. 6 is a combined perspective view showing the configuration of FIG. 5.

FIGS. 7 to 9 are partial perspective views schematically showing a part of the battery pack according to an embodiment of the present disclosure.

FIGS. 10 and 11 are perspective views schematically showing a cell sleeve and a pack case according to an embodiment of the present disclosure, respectively.

FIG. 12 is a cross-sectional view schematically showing a part of a battery pack to which the cell sleeve and the pack case of FIGS. 10 and 11 are applied.

FIG. 13 is a perspective view schematically showing a pack case according to an embodiment of the present disclosure.

FIG. 14 is a cross-sectional view schematically showing a part of a battery pack to which the pack case of FIG. 13 is applied.

FIG. 15 is an exploded perspective view schematically showing cell sleeves according to various embodiments of the present disclosure.

FIG. 16 is a perspective view schematically showing a cell sleeve according to an embodiment of the present disclosure.

FIG. 17 is a perspective view schematically showing a cell sleeve according to an embodiment of the present disclosure.

FIG. 18 is a perspective view schematically showing that the cell sleeve of FIG. 17 is deformed due to gas discharge or the like.

FIG. 19 is a perspective view schematically showing a cell sleeve according to an embodiment of the present disclosure.

FIG. 20 is a perspective view schematically showing that the cell sleeve of FIG. 19 is deformed due to gas discharge or the like.

FIG. 21 is a perspective view schematically showing a part of a battery pack according to an embodiment of the present disclosure.

FIG. 22 is a perspective view schematically showing a vehicle according to an embodiment of the present disclosure.

### DETAILED DESCRIPTION

Further aspects, features, and advantages of the present disclosure will become apparent from the detailed description which follows.

As used herein, the singular forms “a”, “an” and “the” are intended to include the plural forms as well, unless the context clearly indicates otherwise. Additionally, the use of “or” is intended to include “and/or” and not the “exclusive” sense of “either/or, unless the context clearly indicates otherwise.

As used herein, “about” is a term of approximation and is intended to include minor variations in the literally stated amounts, as would be understood by those skilled in the art. Such variations include, for example, standard deviations associated with techniques commonly used to measure the amounts of the constituent elements or components of an alloy or composite material, or other properties and characteristics. All of the values characterized by the above-described modifier “about,” are also intended to include the exact numerical values disclosed herein. Moreover, all ranges include the upper and lower limits.

Any compositions described herein are intended to encompass compositions which consist of, consist essentially of, as well as comprise, the various constituents identified herein, unless explicitly indicated to the contrary.

As used herein, the recitation of a numerical range for a variable is intended to convey that the variable can be equal to any value(s) within that range, as well as any and all sub-ranges encompassed by the broader range. Thus, the variable can be equal to any integer value or values within the numerical range, including the end-points of the range. As an example, a variable which is described as having values between 0 and 10 , can be 0, 4, 2 - 6, 2.75, 3.19 4.47 , etc.

Unless indicated otherwise, each will of the individual features or embodiments of the present specification are combinable with any other individual feature or embodiment that are described herein, without limitation. Such combinations are specifically contemplated as being within the scope of the present disclosure, regardless of whether they are explicitly described as a combination herein.

Technical and scientific terms used herein have the meaning commonly understood by one of skill in the art to which the present description pertains, unless otherwise defined. Reference is made herein to various methodologies and materials known to those of skill in the art.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

The term “exemplary” is used in the sense of “example” rather than “ideal.” The term “or” is meant to be inclusive and means either, any, several, or all of the listed items. The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus.

In the appended drawings, the size of each element or a specific portion constituting the element may be exaggerated, omitted, or schematically illustrated for convenience and clarity of description. Accordingly, the size of each element may not necessarily reflect the actual size. If it is determined that a detailed description of a related known function or configuration may unnecessarily obscure the gist of the present disclosure, such description may be omitted.

As used herein, the term ‘couple’ or ‘connect’ includes not only a case where one member is directly coupled or directly connected to another member, but also a case where one member is indirectly coupled or indirectly connected to another member through a joint member.

The following embodiments describe a cell assembly, a battery pack, and a vehicle including the battery pack and methods of manufacturing the same, in accordance with one or more aspects of the present disclosure.

As described above, there is a need in the battery technology field, particularly in battery packs and vehicles including the same, to improve, for example, energy density, cooling properties, and manufacturing processes. A battery pack may include one or more battery modules, and a battery module requires various accommodating components that are necessary to facilitate proper installation or mounting of the battery module in the battery pack. For example, a battery module requires a module case, a stacking frame, plates, etc. However, such battery module components unnecessarily increase the volume or size of the battery pack. Further, the battery module components limit the storage space available for installing battery cells. That is, battery module requires space in the battery pack to accommodate for the battery module components (e.g., module case, stacking frame, plates, etc.). Further, battery modules require additional space to accommodate for the assembly tolerances necessary for installing battery module components. Accordingly, an assembly process of a battery module can complicate the overall manufacturing process of a battery pack.

Additionally, battery modules present challenges for obtaining desired or improved cooling properties of a battery pack because the structural characteristics of the battery modules complicate the overall layout of the battery pack, making it difficult for modifying battery pack designs for improving or adjusting the cooling properties or capabilities of the battery pack.

According to aspects of the present disclosure, a battery pack that overcomes the forgoing problems may be provided. For example, a battery pack may include one or more cell assemblies. The one or more cell assemblies of the present disclosure may be installed or mounted without the use of components that required in a battery module. In other words, the cell assemblies of the present disclosure may be mounted, for example, directly on the pack assemblies. That is, the cell assemblies may be directly or in directly mounted to the battery pack in a “cell-to-pack” manner without requiring battery module components. Additionally or alternatively, the cell assemblies may be directly mounted to the chassis of a vehicle in a “cell-to-chassis” manner without require battery module components.

A cell assembly according to one or more aspect of the present disclosure may include one or more pouch-type battery cells that are accommodated inside of a cell sleeve. As discussed above, the cell sleeve does not require, among other things, a stacking frame (e.g., a plastic cartridge), a module case, or other components of a battery module. The cell sleeve may include at least two sides or panels that are spaced apart and face each other. One or more pouch-type cells may be accommodated between the two sides. The cell sleeve may be formed by bending a single metal sheet into multiple parts to form the two sides. The cell sleeve may facilitate stacking of the cell assemblies side-by-side in a horizontal or vertical direction. As such, the cell assemblies of the present disclosure may be stored or mounted in the battery pack or vehicle chassis more easily and efficiently.

Since the cell assemblies of the present disclosure do not need the components required for modularization, additional cell assembly units may be provided in the space of a battery pack that is typically required for battery modules. Thus, overall energy density of a battery pack or a vehicle chassis may be increased.

Additionally, a cell sleeve according to aspects of the present disclosure may include one or more open ends that expose at least one surface of a pouch-type battery cell accommodated in the cell sleeve. Accordingly, any heat, gas, and/or flame generated from a pouch-type battery cell may dissipate through the open ends. Further, the discharge direction of the heat, gas, and/or flame may be controlled based on the position of the open ends in relation to the pouch-type battery cell. Accordingly, thermal runaway propagation between adjacent battery cells may be effectively prevented.

A cell assembly according to aspects of the present disclosure may be include a pouch-type battery cell having at least one side or surface that is spaced apart from at least one inner side of the cell sleeve. Accordingly, the cooling efficiency of the cell assembly and the battery pack may be further improved by providing void or space between at least one inner surface of the cell sleeve and a surface of the pouch-type battery cell.

At least one surface of a pouch-type battery cell according to one or more embodiments of the present disclosure may be arranged to contact the pack case directly or indirectly through one or more open ends of the cell sleeve. As such, the heat generated from the pouch-type battery cell may be effectively discharged via the pack case. Additionally, the surface of the pack case may include one or more heat sinks that may facilitate cooling of the pouch-type battery cell through at least one surface of the pouch-type battery cell that contacts the surface of the pack case. Accordingly, concurrent and cooling of the battery pack may be implemented via multiple means through the pack case and the cell sleeve.

Since the cell assemblies according to aspects of the present disclosure do not require battery modules and accompanying module components, the overall manufacturing process for forming a battery pack utilizing the cell assemblies of the present disclosure may be simplified, and the manufacturing time may be reduced. The number of battery cells accommodated by a cell sleeve may also be modified. For example, by changing the dimensions of the cell sleeve, the number of battery cells accommodated in the cell sleeve may be easily changed. Therefore, the capacity or output of the cell assembly for a battery pack may be varied as desired by utilizing a single cell sleeve. Further, a cell sleeve of the present disclosure may provide protection for pouch-type batteries that are vulnerable external impacts or forces. Therefore, the process of handling the pouch-type cell may be performed more easily and safely. For example, a pouch-type battery cell in a cell sleeve of the present disclosure may be prevented from being damaged or broken during the cell assembly handling process, such as installing the cell assemblies with pouch-type batteries inside of a pack case or a chassis of a vehicle.

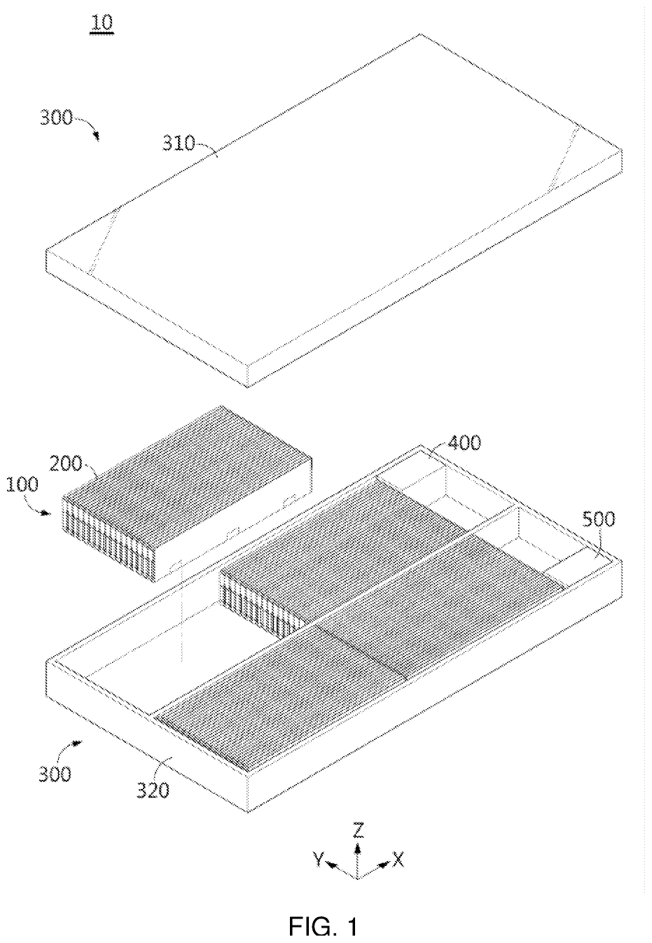

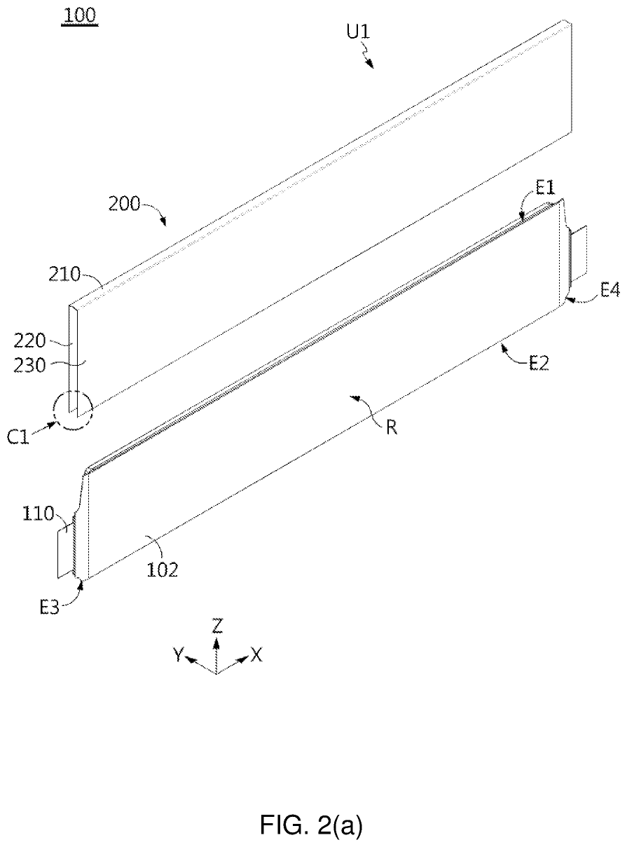

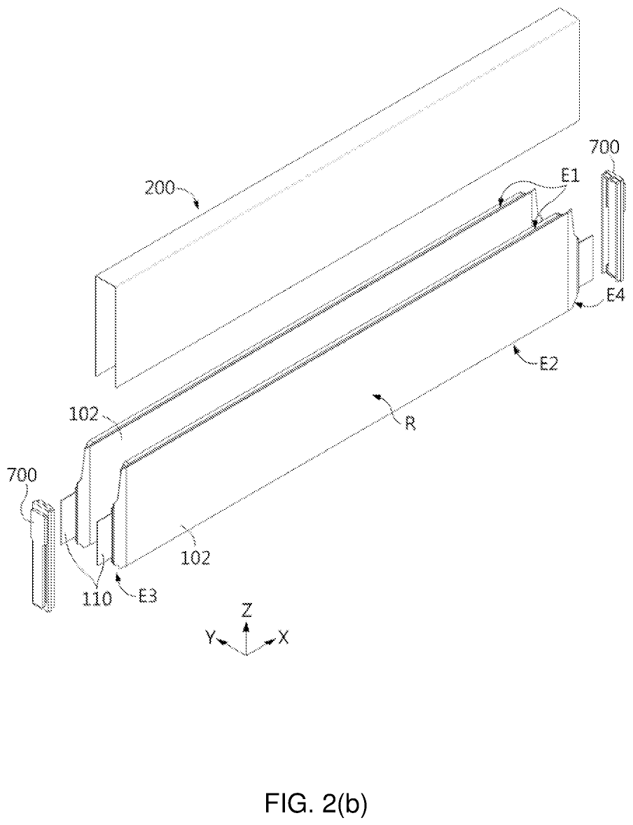

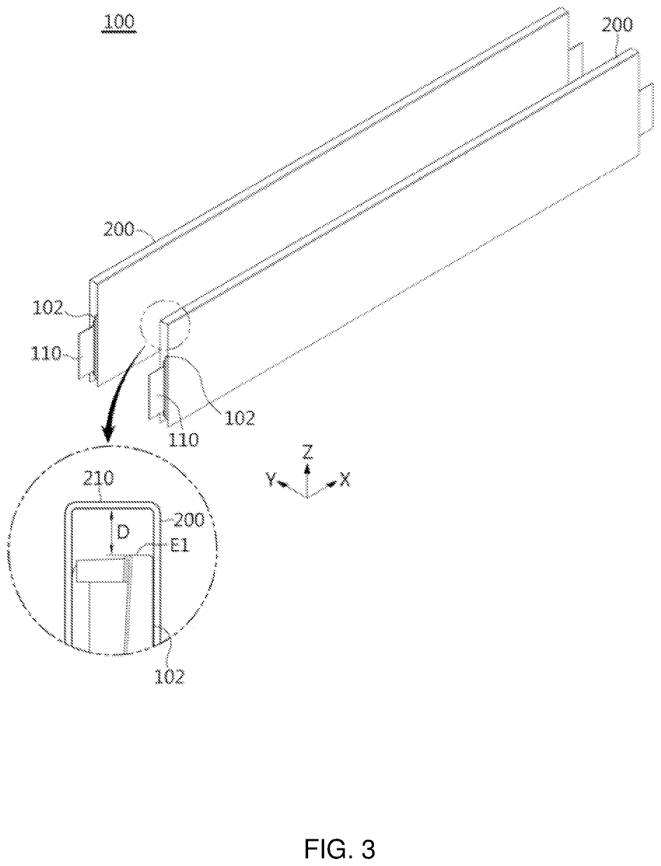

Referring now to the appended drawings, FIG. 1 is a schematic perspective view showing a battery pack according to an embodiment of the present disclosure from which some components are separated. Also, FIG. 2(a) is an exploded perspective view schematically showing a cell assembly including a pouch-type battery cell in a cell sleeve 200 according to an embodiment of the present disclosure, FIG. 2(b) is a schematic perspective view showing a cell assembly including a plurality of pouch-type battery cells in a cell sleeve 200, and FIG. 3 is a perspective view schematically showing a plurality of cell assemblies 100 according to an embodiment of the present disclosure.

Referring to FIG. 1, a battery pack 10 according to an embodiment of the present disclosure may include a battery assembly 100, a pack case 300, and a cell sleeve 200.

Referring to FIG. 2(a), the cell assembly 100 may include a pouch-type battery cell 102. The pouch-type battery cell 102 may include an electrode assembly, an electrolyte, and a pouch having a pouch exterior. Referring back to FIG. 1, a plurality of cell assemblies 100 may be included in the battery pack 10. In addition, the plurality of cell assemblies 100 may be stacked together in at least one direction. For example, referring to FIGS. 1 and 3, the plurality of pouch-type battery cells 102 may be stacked in a horizontal direction, for example in a left and right direction (Y-axis direction in the drawing). In addition, the plurality of pouch-type battery cells 102 may be arranged in a front and rear direction (X-axis direction in the drawing), as shown in FIG. 1. Moreover, the plurality of cell assemblies 100 may be arranged in a horizontal direction to form a plurality of rows of pouch-type battery cells 102 in the left and right direction (Y-axis direction). For example, referring to FIG. 1, the plurality of pouch-type battery cells 102 may be stacked or arranged such that two cell assemblies 100 are arranged in the left and right direction (Y-axis direction) are provided in the front and rear direction. For example, FIG. 1 shows two cell assemblies 100 in the X-axis direction and also shows two cell assemblies 100 in the Y-axis direction.

The battery pack 10 according to the present disclosure may employ various types of pouch-type battery cells 102.

Still referring to FIG. 1, the pack case 300 may include space formed therein to accommodate the plurality of cell assemblies 100. Further, the pack case 300 may include an upper case 310 and a lower case 320, as shown in FIG. 1. In one embodiment, the lower case 320 may be formed in a box shape with an open top, so that a plurality of battery assemblies 100 may be accommodated in the inner space thereof. However, the shape or size of the lower case 320 is not limited thereto. In addition, the upper case 310 may be formed as a cover that covers the top opening of the lower case 320. In one embodiment, the upper case 310 may be formed in a box shape with an open bottom (e.g., a rectangular lid with sidewalls). However, the shape or size of the upper case 310 is not limited thereto. The pack case 300 may be made of a plastic or metal material. However, the pack case 300 may be formed from various suitable exterior materials in accordance with the present disclosure.

Referring to FIG. 2(a), the cell sleeve 200 may be configured to accommodate a pouch-type battery cell 102 to form a cell assembly 100. The cell assembly 100 including the cell sleeve 200 and the pouch-type cell 102 may be accommodated in the inner space of the pack case 300 (e.g., in the lower case 320). In one embodiment, the cell sleeve 200 may be configured to at least partially cover the pouch-type battery cells 102.

Referring to FIG. 2(b), a single cell sleeve 200 may be configured to support a plurality of pouch-type battery cells 102 that may be stacked together by at least partially surrounding and supporting the stacked plurality of pouch-type battery cells 102. The plurality of pouch-type battery cells 102 accommodated in the cell sleeve 200 may then be accommodated or mounted inside the pack case 300, as described in this disclosure. For example, the plurality of pouch-type battery cells 102 may be stacked together in a horizontal direction (Y-axis direction in the drawing) as shown in FIGS. 1 and 3. For example, the cell sleeve 200 may be configured such that the plurality of pouch-type battery cells 102 that are stacked in the horizontal direction (Y-direction) are stably mounted or accommodated in the cell sleeve 200. Accordingly, the plurality of pouch-type battery cells 102 may be directly or indirectly seated (or mounted) and accommodated inside the pack case 300. Alternatively or additionally, a single cell sleeve 200 may be configured to accommodate a plurality of pouch-type battery cells 102 that may be arranged in the X-axis direction. For example, the cell assembly 100 may be a long-cell type cell assembly including a plurality of pouch-type battery cells 102 in the X-axis direction. Alternatively or additionally, a single cell sleeve 200 may be configured to accommodate a plurality of pouch-type battery cells 102 in both the Y-axis direction and the X-axis direction. As such, the size and shape of the cell sleeve 200 may be modified to accommodate a desired number of pouch-type battery cells 102, while maintaining the structural integrity of the cell assembly 100. Additionally, the manufacturing process for the cell assembly 100 may be simplified by providing opening portions in the cell sleeve 200, as shown in FIG. 2(b). For example, a long-cell type battery cell may be easily inserted into the cell sleeve 200 via at least one of the opening portions of the cell sleeve 200. For example, a long-cell type battery cell may be inserted through the opening portion opposite the upper cover 210 of the cell sleeve. Accordingly, the simplified manufacturing process of the cell assembly 100 may increase the overall production yield as well.

In one embodiment, the exterior of the pouch-type battery cells 102 may be made of soft material. However, the pouch-type battery cells 102 with soft exterior may be vulnerable to external impact and have low hardness. Therefore, mounting or accommodating the pouch-type battery cells 102 inside a battery pack case may be difficult without utilizing a battery module case. However, according to the present disclosure, the plurality of pouch-type battery cells 102 may be amounted directly or indirectly inside the pack case 300 without requiring any battery modules or module components since the plurality of pouch-type battery cells 102 are at least partially covered by and accommodated in the cell sleeve 200. That is, a single cell sleeve 200 may be sufficient to provide structural integrity to the plurality of pouch-type battery cells 102 to be stacked and directly or indirectly mounted in the pack case 300.

Therefore, according to aspects of the present disclosure, the battery pack 10 does not require battery module components such as a module case, a stacking frame, a fastening member (e.g., a bolt), etc. for the battery cells to be mounted or accommodated in the battery pack 10, while maintaining the stacked configuration of the battery cells 102, as shown in FIGS. 1 and 3 for example. Accordingly, the space occupied by other components, such as a battery module case or a stacking frame, or space reserved for securing a tolerance for accommodating battery modules may be eliminated. Therefore, a greater number of cell assemblies 100, which do not require the components of battery modules, may be provided in the battery pack 10, compared to the number of battery cells utilizing battery modules that can be mounted in the battery pack 10. As such, the energy density of the battery pack 10 accommodating the cell assemblies 100 of the present disclosure may be further improved compared to a battery pack accommodating battery modules.

Further, since a battery module case, a stacking frame, bolts, or the like are not required in the present disclosure, the volume or weight of the battery pack 10 may be reduced, and the manufacturing process may also be simplified.

Furthermore, according to aspects of the present disclosure, the pouch-type battery cells 102 in the cell sleeve 200 may be handled more easily during manufacturing. For example, when the plurality of pouch-type battery cells 102 are accommodated inside the pack case 300, the pouch-type battery cells 102 may be gripped by a jig or the like. That is, the jig may grip the outer surfaces of the cell sleeve 200 surrounding the pouch-type battery cells 102 without directly gripping the pouch-type battery cells 102. Accordingly, it the pouch-type battery cells 102 are prevented from being damaged or broken by the jig.

In addition, according to aspects of the present disclosure, since the cell sleeve 200 is coupled to or at least partially covers the pouch-type battery cells 102, the pouch-type battery cells 102 are effectively protected without requiring a battery module case.

The cell sleeve 200 may be made of various materials to ensure rigidity. In one embodiment, the cell sleeve 200 may be made of a metal material. The metal material may more stably maintain the stacking state of the pouch-type battery cells 102 and more safely protect the pouch-type battery cells 102 from external impact. In particular, the cell sleeve 200 may include a steel material, furthermore a stainless steel (SUS) material. For example, the cell sleeve 200 may be entirely made of SUS material.

If the cell sleeve 200 is made of steel as described above, which has excellent mechanical strength or rigidity, the stacking state or configuration of the pouch-type battery cells 102 may be more stably supported. For example, the pouch-type battery cells 102 may stand on their own vertically in the Z-direction without falling over. In addition, the pouch-type battery cells 102 are more effectively prevented from being damaged or broken due to an external impact, for example by a needle-like body.

In addition, if the cell sleeve 200 is made of steel, which has a high melting point, when a flame is generated from a battery cell 102, the overall structure of the cell assembly 100 may be stably maintained. For example, since steel has a higher melting point than aluminum, the cell sleeve 200 that is made of steel may not melt from the flame ejected from the battery cell 102 but may stably maintain its shape. Accordingly, the flame propagation prevention or delay effect and the venting control effect may be excellent between the battery cells 102 or cell assemblies 100.

The cell sleeve 200 may be configured to surround one or more pouch-type battery cells 102. For example, as shown in FIGS. 2(a), 2(b), and 3, one cell sleeve 200 may be configured to cover at least one pouch-type battery cell 102. In one embodiment, a cell sleeve 200 may individually accommodate or cover a pouch-type battery cells 102, as shown in FIG. 2(a). Alternatively, the cell sleeve 200 may be configured to accommodate and cover two or more pouch-type battery cells 102 together, as shown in FIG. 2(b).

The cell sleeve 200 may be at least partially adhered to an outer surface of the battery cell 102. For example, an inner surface of the cell sleeve 200 may be adhered to the accommodation portion (or at least one surface) of the pouch-type battery cell 102. In one embodiment, the cell sleeve 200 may be adhered to an outer surface of the battery cell 102 by an adhesive material.

In one embodiment, one or more cell sleeves 200 may be included in the battery pack 10. For example, the cell sleeve 200 may be configured to accommodate a group of a plurality of pouch-type battery cells 102 to form a cell assembly 100. For example, one cell sleeve 200 having a plurality of pouch-type batteries 102 may constitute one cell assembly 100, as shown in FIG. 2(b) for example. As such, one cell assembly 100 may include one pouch-type battery cell 102 or a plurality of pouch-type battery cells 102. For example, the cell assembly 100 having a single pouch-type battery cell 102 in a single cell sleeve 200 is shown in FIG. 2(a). In one embodiment, the cell assembly 100 may be referred to a cell unit U1. In other words, the cell unit U1 may be a component of the cell assembly 100 or the cell assembly 100 itself. Further, FIG. 3 shows a cell assembly including two sleeves 200 having one pouch-type battery cells 102 in each of the sleeves 200. In one embodiment, two sleeves 200 being combined together may be referred to as a cell assembly 100. Additionally or alternatively, each of the cell sleeves 200 shown in FIG. 3 may include a plurality of pouch-type battery cells 102, similar to the cell assembly 100 shown in FIG. 2(b).

In one embodiment, the battery pack 10 may include a plurality of cell assemblies 100. Accordingly, a plurality of cell sleeves 200 may be included in the battery pack 10. For example, if the cell sleeve 200 is configured to surround one pouch-type battery cell 102, the battery pack may include the same number of cell sleeves 200 as the number of pouch-type battery cells 102. Alternatively or additionally, if the cell sleeve 200 is configured to surround two or more pouch-type battery cells 102, the battery pack may include a smaller number of cell sleeves 200 than the number of pouch-type battery cells 102.

The cell sleeve 200 may be configured to support a plurality of pouch-type battery cells 102 in a standing state or configuration, as shown in FIG. 2(a). Each pouch-type battery cell 102, as shown in FIG. 2(a), may have two wide surfaces, and a sealing portion or a folded portion of the pouch exterior may exist at an edge of a wide surface of the pouch-type battery cell 102. As such, in some embodiments, it may be difficult to stack the pouch-type battery cells 102 in a standing state in the upper and lower direction if the sealing portion is on the bottom surface of the pouch-type battery cell 102. However, in the battery pack 10 according to the present disclosure, the cell sleeve 200 may be configured to accommodate or surround one or more pouch-type battery cells 102 to facilitate accommodating or mounting the cell assembly 100 in the battery pack 10. That is, the pouch-type battery cells 102 may be accommodated in the cell sleeve 200 with the sealing portion facing the inner surface of the battery pack. The two surfaces 220 and 230 may support the cell assembly 100 to stand in the Z-direction without the aid of the pouch-type battery cells 102 or other means.

In one embodiment, the cell sleeve 200 may be configured such that the plurality of pouch-type battery cells 102 may be stacked in a horizontal direction in a state of standing in the upper and lower direction (Z-direction). For example, as shown in FIGS. 1 and 3, the plurality of cell sleeves 200 may be stacked on each other in the horizontal direction, and each cell sleeve 200 may be configured to surround one or more pouch-type battery cells 102. In this case, the configuration in which the plurality of pouch-type battery cells 102 are stacked side by side in the horizontal direction in a standing state may be stably maintained by the cell sleeve 200.

In one embodiment, the cell sleeve 200 may be configured to stand on its own without the aid of any other means in the inner space of the pack case 300, for example as shown in FIG. 3. That is, the cell sleeve 200 may be configured to maintain a standing state on its own without the aid of other components provided in the battery pack, such as the pack case 300 or the pouch-type battery cells 102.

In one embodiment in accordance with FIG. 1, the cell sleeve 200 may be seated directly on the bottom surface of the lower case 320. That is, a part of the cell sleeve 200, for example a lower end of the cell sleeve 200 indicated by C1 in FIG. 2(a), may be arranged to be in direct contact with the bottom surface of the lower case 320. In addition, the cell sleeve 200 may be configured so that the cell sleeve 200 may be stationary in the upright position in a stable manner, as shown in FIG. 3. Accordingly, if the cell sleeve 200 is made of a metal material with excellent rigidity such as steel, in particular a SUS material, the self-standing state may be more stably maintained. Therefore, the standing state of the pouch-type battery cells 102 may be more reliably supported.

The cell sleeve 200 may be configured to partially surround the pouch-type battery cell 102 so that at least one side of the surrounded pouch-type battery cell 102 is exposed to the outside. That is, the cell sleeve 200 may not completely cover the pouch-type battery cell 102 as a whole, but may be configured to cover only a part thereof. In one embodiment, the cell sleeve 200 may be configured such that at least one side of the pouch-type battery cell 102 is exposed toward the pack case 300.

For example, as shown in FIGS. 2(a), 2(b), and 3, the cell sleeve 200 may be configured to surround at least one pouch-type battery cell 102, and the lower portion of the surrounded pouch-type battery cell 102 accommodated in the inner space, may surrounded by the cell sleeve 200. Accordingly, the lower portion of the battery cell 102 may be exposed toward the pack case 300 to directly face the pack case 300. As shown in FIG. 1, the lower portion of the battery cell 102 may be exposed toward the bottom surface of the lower case 320.

According to aspects of the present disclosure, the cooling performance of the battery pack 10 may be secured more effectively. For example, the pouch-type battery cell 102 and the pack case 300 may be in direct contact with the surface of the pack case 300. Accordingly, the heat emitted from each pouch-type battery cell 102 may be directly transferred to the pack case 300, thereby improving cooling performance Additionally, since a separate cooling structure does not need to be provided between the pouch-type battery cell 102 and the pack case 300, efficient cooling performance may be realized. Further, a space for introducing a coolant such as air may not be provided between the pouch-type battery cells 102.

Each pouch-type battery cell 102 may include an accommodation portion indicated by R and edge (or side) portions indicated by E1 to E4, as shown in FIG. 2(a). Here, the accommodation portion (or surface) R may be a portion in which an electrode assembly in which a positive electrode plate and a negative electrode plate are stacked with a separator interposed therebetween is accommodated. In addition, an electrolyte may be accommodated in the accommodation portion R. Also, the edge portions E1 to E4 may be arranged in the form of surrounding the accommodation portion R.

In one embodiment, an edge portion (El to E4) may be a sealing portion where the pouch exterior of the pouch-type battery cell 102, is sealed. For example, as shown in FIG. 2(a), four edge portions may be provided, and they may be located at an upper corner, a lower corner, a front corner, and a rear corner, respectively, based on the accommodation portion R, for example as shown in FIG. 2(a). In one embodiment, all of the four edge portions E1 to E4 may include sealing portions. Alternatively, some of the four edge portions E1 to E4 may be configured in a folded form rather than a sealing portion. For example, as shown FIG. 2(a), the upper edge portion E1, the front edge portion E3, and the rear edge portion E4 may all be sealing portions, but the lower edge portion E2 may be a folded portion of the pouch exterior. For example, a battery cell in which all four edge portions E1 to E4 are sealed may be referred to as a four-sided sealing cell, and a battery cell in which three edge portions E1, E3, E4 are sealed may be referred to as a three-sided sealing cell.

In one embodiment, the cell sleeve 200 may be configured to surround both sides of the accommodation portion R of the pouch-type battery cell 102 and a part of the edge portions E1 to E4. For example, as shown in FIG. 2(a), when one cell sleeve 200 is configured to surround one pouch-type battery cell 102, the cell sleeve 200 may be configured to surround both surfaces of the accommodation portion R of the corresponding pouch-type battery cell 102 (e.g., the left surface and the right surface of the corresponding accommodation portion R) and a part of the edge portion of the corresponding battery cell 102 from the outside. In one embodiment, the edge portion E3 may be adjacent or proximate to an open end or portion between the first side cover 220 and the second side cover 230 that are next to the edge portion E3, as shown in FIG. 2(a).

In one embodiment, the edge portion E3 being adjacent or proximate to the open end or portion between the first side cover 220 and the second side cover 230 may be defined as the edge portion E3 being fully covered by the first side cover 220 and the second side cover 230. Alternatively, the edge portion E3 being adjacent or proximate to the open end or portion between the first side cover 220 and the second side cover 230 may be defined as protruding or exposed beyond the edges of the first side cover 220 and the second side cover 230 that are next to the edge portion E3. Additionally or alternatively, the edge portion E4 may be adjacent or proximate to an open portion between the first side cover 220 and the second side cover 230 that are next to the edge portion E4, as shown in FIG. 2(a). The edge portion E4 being adjacent or proximate to the open end or portion between the first side cover 220 and the second side cover 230 may be defined similarly to the edge portion E3 being adjacent or proximate to the open end or portion between the first side cover 220 and the second side cover 230, as described above.

Additionally or alternatively, when one cell sleeve 200 is configured to surround a plurality of pouch-type battery cells 102, as shown in FIG. 2(b), for example a plurality of battery cells 102 arranged in the left and right direction (Y-direction), the cell sleeve 200 may be configured to surround the outer surfaces of the accommodation portion (e.g., R) of the outermost battery cells and at least one edge portion (e.g., E1) of each of all the battery cells 102. In one embodiment, one cell sleeve 200 may be configured to surround three pouch-type battery cells 102 stacked in the left and right direction (Y-axis). In this case, the cell sleeve 200 may be configured to cover the left surface of a left most battery cell, at least one edge portion (e.g., E1) of each of the three battery cells 102, and the right surface of the right battery cell.

In one embodiment, a single cell sleeve 200 may support and protect one or more pouch-type battery cells 102, as shown in FIGS. 2(a) and ( b ). Additionally, through the cell sleeve 200, the process of handling one or more pouch-type battery cells 102 may be easily and safely performed. Additionally, one cell sleeve 200 may contact the surfaces of two accommodation portions R on the pouch-type battery cells 102 accommodated therein. Accordingly, the cooling performance between the accommodation portion R and the cell sleeve 200 may be further improved. Accordingly, the surface cooling may be implemented through the wide surface of the accommodation portion R, so that the cooling efficiency may be improved.

In a battery pack 10 according to aspects of the present disclosure, a TIM (Thermal Interface Material) may be interposed between different components in order to increase heat transfer performance For example, the TIM may be filled between the battery cell 102 and the cell sleeve 200, between the cell sleeve 200 and the pack case 300, and/or between the battery cell 102 and the pack case 300. Accordingly, the cooling performance of the battery pack 10, for example dual (or multiple) cooling performance or the like, may be further improved.

In one embodiment, the cell sleeve 200 may be configured to surround an edge portion not having an electrode lead among several edge portions (e.g., E1-E4) of the pouch-type battery cell 102 accommodated therein. For example, as shown in FIG. 2(a), the pouch-type battery cell 102 may include two electrode leads 110, namely a positive electrode lead and a negative electrode lead. For example, the two electrode leads may be respectively located at the front edge portion E3 and the rear edge portion E4. At this time, the cell sleeve 200 may be configured to surround one of two edge portions E1, E2 in addition to the front edge portion E3 and the rear edge portion E4.

Referring to FIGS. 2(a), ( b ), and 3, the pouch-type battery cell 102 may be formed in an approximately hexahedral shape. In addition, the electrode leads 110, the negative electrode lead and the positive electrode lead, may be formed at two of the six surfaces, respectively. In addition, the cell sleeve 200 may be provided to surround at least a part of three surfaces among four surfaces other than the two surfaces where the electrode lead 110 is formed in the pouch-type battery cell 102 having six surfaces.

According to aspects of the present disclosure, the emission direction of the flame or the like may be directed toward the exposed side of the cell sleeve 200. For example, since the front side and the rear side of the cell sleeve 200 where the electrode lead 110 is located are open, the flame may be discharged toward the open end or portion. In one embodiment, when the cell sleeve 200 is configured to have open front and rear sides as described above, side directional venting may be easily implemented. Additionally or alternatively, the cell sleeve 200 may have an opening portion opposite the upper cover 210 to allow directional venting in the direction of the opening portion.

Moreover, the cell sleeve 200 may be provided to cover both sides of the accommodation portion R and the upper edge portion E1 with respect to one or more pouch-type battery cells 102 accommodated and surrounded therein. For example, referring to FIG. 2(a), the cell sleeve 200 may be configured to surround all of the left and right surfaces of the accommodation portion R and the upper edge portion E1 with respect to one pouch-type battery cell 102. Alternatively, when the cell sleeve 200 is configured to surround two pouch-type battery cells 102 stacked in the left and right direction (Y-axis), the cell sleeve 200 may be configured to surround the left surface of the accommodation portion R of the left battery cell 102, the upper edge portions E1 of the two battery cells, the right surface of the accommodation portion R of the right battery cell 102.

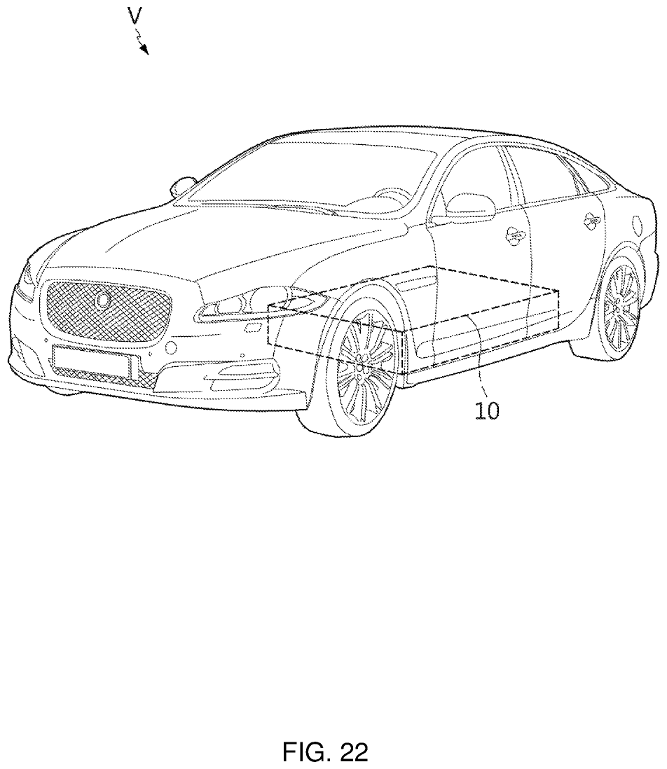

According to aspects of the present disclosure, by using one cell sleeve 200, a configuration for supporting and protecting one or more battery cells is easily implemented. In one embodiment, the lower edge portion E2, which may be located adjacent or proximate to an opening portion of the cell sleeve 200, may face the surface and be in direct contact with the pack case 300 without being surrounded by the cell sleeve 200. That is, at an open end of the cell sleeve 200, as shown in FIG. 2(a). Accordingly, the heat of the pouch-type battery cell 102 surrounded by the cell sleeve 200 may be quickly and smoothly (or consistently and effectively) discharged toward the lower pack case 300. Further, the cooling performance of the battery pack may be secured and achieved more effectively. The cooling configuration may be implemented more effectively when cooling is mainly performed in the lower portion of the pack case 300. For example, as shown in FIG. 22, since a battery pack 10 mounted to an electric vehicle V is mounted to a lower portion of a vehicle body, cooling may be mainly performed in the lower portion of the pack case 300. For example, when the lower edge portion E2 of each pouch-type battery cell 102 is in contact with the surface of the pack case as in this embodiment, heat is rapidly transferred from each battery cell 102 toward the pack case 300, improving the cooling performance of the battery pack 10. When a high-temperature gas or flame is discharged from the pouch-type battery cell 102, for example during a thermal runaway, the discharged gas or flame is effectively prevented by being directed to the upper side. For example, when an occupant or rider of a vehicle is located at an upper side of the battery pack 10, such as in an electric vehicle V, the gas or flame is suppressed or delayed from being directed toward the occupant or rider.

In one embodiment, the pack case 300 may include internal space that may be enclosed or at least partially exposed the outer environment. As such, in some cases, the pack case 300 may be sealed to prevent any damage from water or dust. However, in order to vent any gas generated from the cell assembly 100, one or more venting holes may be provided on the pack case 300.

Still referring to FIG. 2(a), using a cell sleeve 200 having a configuration with an open end opposite the upper cover 210 so as to expose the lower edge portion E2 of the battery cell 102 for contacting the surface of the pack case 300 allows reduction of overall weight of the cell assembly 100. For example, if the cell sleeve 200 is made of steel, significant overall weight reduction of the cell assembly 100 may be achieved by having the opening portions in the cell sleeve 200, including the opening portion opposite the upper cover 210, as shown in FIG. 2(a).

Referring to FIGS. 2(a), ( b ), and 3, the cell sleeve 200 may be formed in a shape similar to an n-shape. Based on the shape, the cell sleeve 200 may be configured to cover portions of the pouch-type battery cell 102 accommodated therein other than the front side (e.g., E3) and the rear side (e.g., E4) where the electrode lead protrudes and the lower side (e.g., E2). That is, the cell sleeve 200 may be provided to cover the outer side (e.g., R) and the upper side (e.g., E1) of the accommodation portion of the pouch-type battery cell accommodated therein.

As shown in FIGS. 2(a), ( b ), and 3, the cell sleeve 200 may include an upper cover (or upper surface) 210, a first side cover (or side surface) 220, and a second side cover (or side surface) 230. Alternatively, the cover (201, 220, or 230) may be alternatively described as a side, a surface, a panel, or an end of the cell sleeve.

In one embodiment, the upper cover 210 may be configured to surround the upper part of the upper edge portion E1 of the pouch-type battery cell 102 accommodated therein. In particular, the upper cover 210 may be configured to be in contact with or spaced apart from the upper edge portion E1 of the pouch-type battery cell 102. FIG. 3 shows one example of the upper cover 210 configured to be spaced part from the upper edge portion E1 by a predetermined distance D in a magnified cross-sectional view of the cell assembly 100. For example, the upper edge portion E1 of a pouch-type battery cell 102 may be spaced apart from an inner surface of the upper cover 210 of the cell sleeve 200 by the predetermined distance D. The distance D may be determined based on various factors, for example based on various structural and thermal characteristics of the battery cell 102 and the cell sleeve 200. In addition, the upper cover 210 may be configured in a planar shape. In this case, the upper cover 210 may have a straight cross section in the horizontal direction to surround the upper edge portion E1 of the pouch-type battery cell 102 in a straight form from the outside. Alternatively, the upper cover 210 may have a curved surface, but is not limited thereto.

In one embodiment, the first side cover 220 may be configured to extend in the lower direction (e.g., Z-direction) from one end of the upper cover 210, as shown in FIG. 2(a). For example, the first side cover 220 may be configured extend in the lower direction ( Z-axis direction in the drawing) on the left end of the upper cover 210. Moreover, the first side cover 220 may be formed in a planar shape, but is not limited thereto. In this case, the first side cover 220 may be configured to be bent from the upper cover 210.

In addition, the first side cover 220 may be configured to surround an outer side of the accommodation portion R at one side of the pouch-type battery cell 102 accommodated therein. For example, when one pouch-type battery cell 102 is accommodated in the cell sleeve 200, the first side cover 220 may be configured to cover the left surface of the accommodation portion R of the accommodated pouch-type battery cell 102 from the left side. Here, the first side cover 220 may be in direct contact with the outer surface R of the accommodation portion of the battery cell 102.

The second side cover 230 may be positioned to be spaced apart from the first side cover 220 in a horizontal direction (e.g., Y-direction), as shown in FIG. 2(a). In addition, the second side cover 230 may be configured to extend in the lower direction from the other end of the upper cover 210. For example, the second side cover 230 may be configured to extend in the lower direction (e.g., Z-direction) from the right end of the upper cover 210. Moreover, the second side cover 230 may also be configured in a planar shape similar to the first side cover 220. Further, the second side cover 230 and the first side cover 220 may be arranged parallel to each other while being spaced apart in the horizontal direction (e.g., Y-direction), as shown in FIG. 2(a).

In addition, the second side cover 230 may be configured to surround the outer side of the accommodation portion at the other side of the pouch-type battery cell 102 accommodated therein. For example, when one pouch-type battery cell 102 is accommodated in the cell sleeve 200, the second side cover 230 may be configured to surround the right surface of the accommodation portion R of the accommodated pouch-type battery cell 102 from the right side. Here, the second side cover 230 may be in direct contact with the outer surface R of the accommodation portion.

In one embodiment, the inner space of the cell sleeve 200 may be defined by the upper cover 210, the first side cover 220 and the second side cover 230. In addition, the cell sleeve 200 may accommodate one or more battery cells in the inner space as defined above.

Additionally or alternatively, the lower ends of the first side cover 220 and the second side cover 230 as indicated by C1 in FIG. 2(a) may be in contact with the bottom surface of the pack case 300. In one embodiment, the contact configuration between the lower ends of the first side cover 220 and the second side cover 230 and the pack case 300 may be formed to be elongated in the front and rear direction (X-axis direction in the drawing). Accordingly, the self-standing configuration of the cell sleeve 200 capable of maintaining the pouch-type battery cell 102 accommodated therein in an upright state (e.g., in the Z-axis direction) may be more stably implemented.

In one embodiment, the first side cover 220 and the second side cover 230 may have the same height as each other. That is, the lengths of the first side cover 220 and the second side cover 230 extending in the lower direction (e.g. Z-axis direction) from the upper cover 210 may be the same. Accordingly, the self-standing configuration of the cell sleeve 200 may be more easily achieved.

In one embodiment, the upper cover 210 of the cell sleeve 200 may face the upper edge portion E1 of the pouch-type battery cell 102, and may surround the upper edge portion E1 together with the first side cover 220 and the second side cover 230.

In one embodiment, the cross-sectional areas of the first side cover 220 and the second side cover 230 may be larger than the cross-sectional area of the pouch-type battery cell 102 facing the first side cover 220 and the second side cover 230, thereby preventing the accommodation portion R from being exposed to the outside of the cell sleeve 200 and thus securing safety as much as possible.

In one embodiment, the pouch-type battery cell 102 may include a sealing portion and a non-sealing portion as the edge portions E1 to E4. For example, as shown in FIG. 2(a), the upper edge portion E1 may be a DSF (Double Side Folding) portion serving as a sealing portion of the pouch-type battery cell 102, and the lower edge portion E2 may be a non-sealing portion of the pouch-type battery cell 102. The non-sealing portion of the pouch-type battery cell 102 may be defined as a portion that does not require sealing. For example, a non-sealing portion of the pouch-type battery cell 102 may refer to any outer surface of the pouch-type battery cell 102 that does not require sealing. Of course, one or more openings on the pouch of the pouch-type battery cell 102 may be the sealing portions configured to seal off the pouch after inserting an electrode assembly, for example.

Here, the cell sleeve 200 may be configured to surround the pouch-type battery cell 102 such that, among the edge portions E1 to E4, at least a part of the sealing portion is surrounded by the cell sleeve 200 and at least a part of the non-sealing portion is not surrounded but exposed to the outside of the cell sleeve 200. For example, as shown in FIG. 2(a), the cell sleeve 200 may be configured to cover the upper edge portion E1 that is a part of the sealing portion of the pouch-type battery cell 102. In this case, the pouch-type battery cell 102 accommodated in the cell sleeve 200 may be configured such that the upper edge portion E1 serving as the sealing portion may face the upper cover 210. In addition, the cell sleeve 200 may surround the pouch-type battery cell 102 so that the lower edge portion E2 serving as a non-sealing portion of the pouch-type battery cell 102 is exposed to the outside or adjacent to an open end of the cell sleeve 200 (e.g., a flat outer surface of the pouch-type battery cell 102 is adjacent to an open end of the cell sleeve 200). Accordingly, the lower edge portion E2 serving as a non-sealing portion of the pouch-type battery cell 102 may be disposed at the open surface or end of the cell sleeve 200.

In one embodiment, the upper edge portion E1 of the pouch-type battery cell 100 serving as a sealing portion may be more vulnerable to the discharge of relatively high-temperature gas or flame than the lower edge portion E2 serving as a non-sealing portion. However, according to this embodiment, the upper edge portion E1 serving as a sealing portion is disposed to face the upper cover 210, which may be more advantageous for directional venting.

In addition, in the pouch-type battery cell 102, the lower edge portion E2 serving as a non-sealing portion may have and a flat shape with a relatively wider cross-sectional area than the upper edge portion E1 serving as a sealing portion. The lower edge portion E2 may be disposed at the open surface or end of the cell sleeve 200 and may be in direct contact with a thermal resin 326, explained later, to improve the cooling efficiency.

Furthermore, when the lower case 320 is seated on one surface of the body of the vehicle V, the first side cover 220 and the second side cover 230 may extend from the upper cover 210 toward one surface of the body of the vehicle V, and the upper edge portion El may be disposed further away from one surface of the body of the vehicle V rather than the lower edge portion E2. That is, when the lower case 320 is seated on one surface of the body vehicle V, as shown in FIG. 22, the cell sleeve 200 may be configured such that portions of the cell sleeve 200 close to one surface of the body of the vehicle body is open ended, as shown, for example, in C1 of FIG. 2(a).

Alternatively, when the upper case 310 is seated on one surface of the body of the vehicle V, the first side cover 220 and the second side cover 230 may extend from the upper cover 210 away from the one surface of the body of the vehicle V, and the upper edge portion E1 may be disposed closer to one side of the body of the vehicle V rather than the lower edge portion E2. That is, when the upper case 310 is seated on one surface of the body of the vehicle V, the cell sleeve 200 may be configured such that an open end of the cell sleeve (e.g., as shown in C1 of FIG. 2(a)) 200 may be far from one surface of the body of the vehicle body V.

That is, the arrangement of the cell sleeve 200 and the pouch-type battery cell 102 may be variably set based on the relationship between the body of the vehicle V, the pack case 300, and the components disposed on the body of vehicle V other than the pack case 300.

Further, although the cell sleeve 200 is shown or described as being n-shaped in one embodiment, the cell sleeve 200 may be configured in other various shapes. For example, the cell sleeve 200 may be formed in various other shapes such as an I-shape, a U-shape, or an L-shape.

In one embodiment, the cell sleeve 200 may have a U-shape. In this embodiment, configuration of the cell assembly may be reversed compared to the cell assembly 100, as shown in FIG. 3. That is, the upper cover 210 may face and be coupled to the surface of the lower case 320, instead of the opening portion opposite the upper cover 210 being coupled to the surface of the lower case 320, as shown in FIG. 1. As such, the opening portion of a U-shape cell sleeve may function as a venting portion directing heat or gas in the +Z-direction.

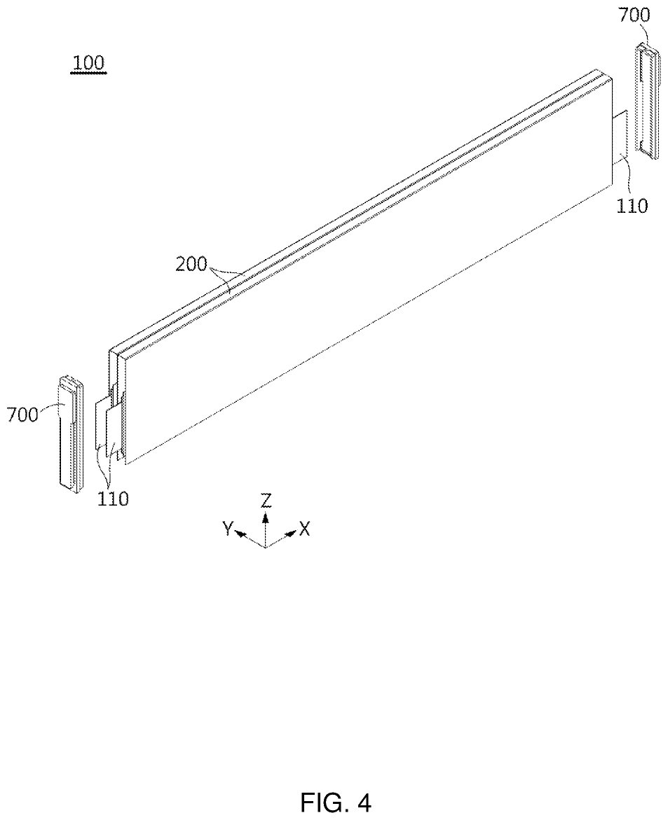

FIG. 4 is an exploded perspective view schematically showing a part of the battery pack according to an embodiment of the present disclosure.

Referring to FIG. 4, the battery pack 10 according to the present disclosure may further include a connector (or bus bar) assembly 700. The connector assembly 700 may also be referred to as a bus bar assembly in the present disclosure. Here, the connector assembly (or connector) 700 may be configured to electrically connect a plurality of pouch-type battery cells 102 to each other. For example, as shown in FIG. 4, the connector assembly 700 may be coupled to the electrode leads 110 of two pouch-type battery cells 102 to electrically connect the two pouch-type battery cells 102 in series and/or in parallel. The connector assembly 700 may include a connector (or bus bar) terminal made of an electrically conductive material such as copper or aluminum to directly contact the electrode lead 110 and a connector (bus bar) housing made of an electrically insulating material such as plastic to support the connector (bus bar) terminal.

In one embodiment, the electrode leads 110 may be provided at both sides of the pouch-type battery cell 102. The connector (bus bar) assembly 700 may also be provided to both sides where the electrode leads 110 are provided. For example, as shown in FIG. 4, when the electrode leads 110 protrude in both the front direction ( X-axis direction in the drawing) and the rear direction (+X-axis direction in the drawing), the connector (bus bar) assembly 700 may be located at both the front side and the rear side of the pouch-type battery cells 102, where the electrode leads 110 are provided.

The connector (bus bar) assembly 700 may be coupled with one or more cell sleeves 200. For example, referring to FIG. 4, two cell sleeves 200 may be configured to surround different pouch-type battery cells 102, respectively, and be stacked in the horizontal direction. In one embodiment, the connector (bus bar) assembly 700 may be coupled to the front and rear ends of the two cell sleeves 200, respectively. For example, one connector (bus bar) assembly 700 may be coupled to the ends of two cell sleeves 200. alternatively, one connector (bus bar) assembly 700 may be coupled to the end of one cell sleeve 200, as shown in FIG. 2(b). In this embodiment, one or more pouch-type battery cells 102 may be accommodated in one cell sleeve 200.

The connector (bus bar) assembly 700 may be coupled with the cell sleeve 200 in various ways. For example, the connector (bus bar) assembly 700 may be coupled and fixed to the cell sleeve 200 through various fastening methods such as bonding, welding, fitting, hook-coupling, bolting, and riveting, but is not limited thereto.

As described in the forgoing embodiments, the plurality of pouch-type battery cells 102 may be made into a unit by utilizing the cell sleeve 200. Alternatively or additionally, the plurality of pouch-type battery cells 102 may also be made into a unit by the connector (bus bar) assembly 700. According to embodiments of FIG. 4, two pouch-type battery cells 102 and two cell sleeves 200 may be coupled together by the same bus bar assembly 700. In this case, the two pouch-type battery cells 102 and the two cell sleeve 200 shown in FIG. 4 may be included in one cell assembly 100. That is, it may be regarded that the configuration shown in FIG. 4 represents one cell assembly 100.

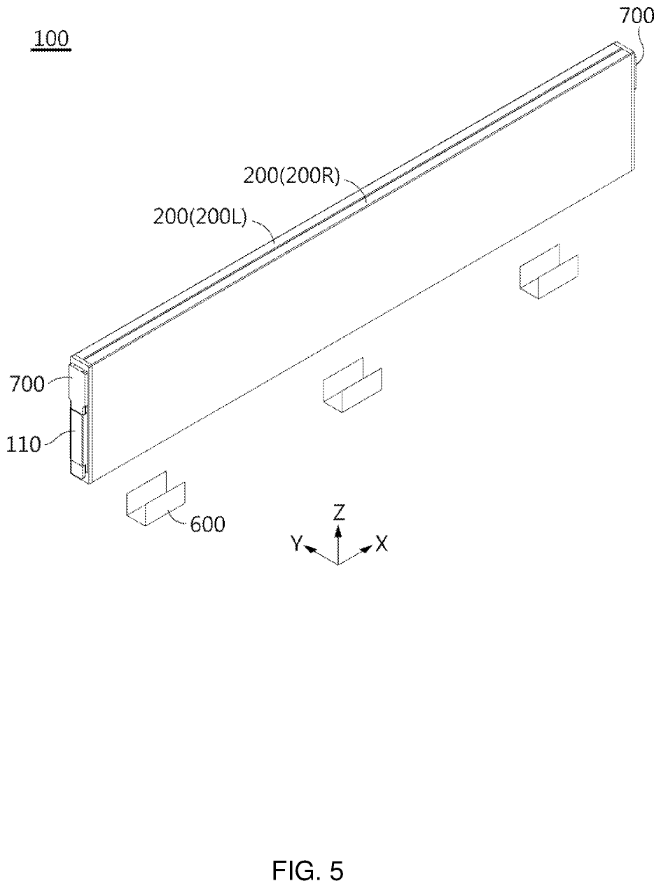

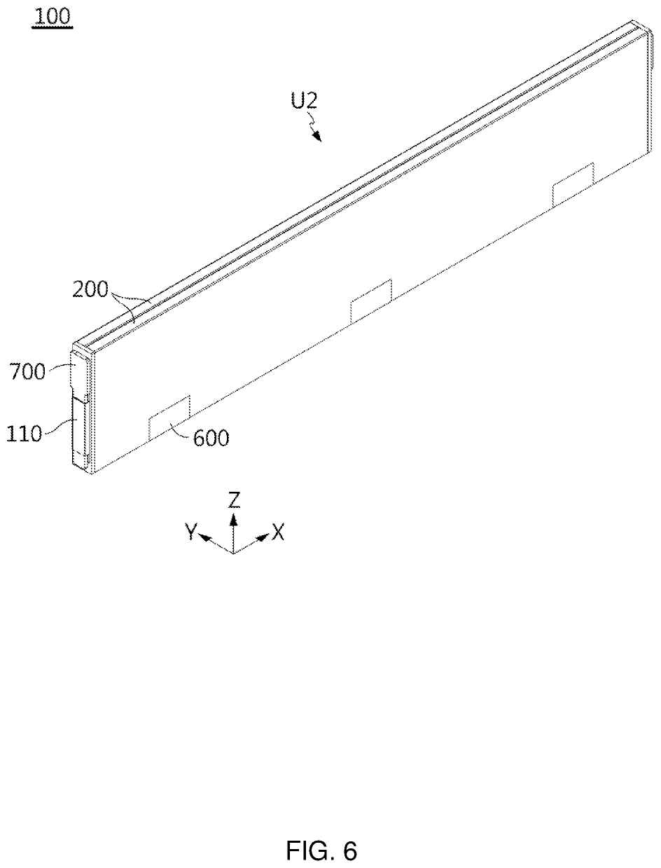

FIG. 5 is an exploded perspective view schematically showing a cell assembly 100 according to an embodiment of the present disclosure, and FIG. 6 is a combined perspective view showing the configuration of FIG. 5.

Referring to FIGS. 5 and 6, the battery assembly 100 according to the present disclosure may further include a taping member 600. The taping member 600 may be configured to couple different ends of the cell sleeve 200 to each other as shown in FIGS. 5 and 6. Similarly, in some embodiments, the taping member 600 may be configured to couple different ends of the cell sleeves 200 shown in FIGS. 2(a)-4. In one embodiment, the taping member 600 may include a base layer and an adhesive layer formed on the surface of the base layer. For example, different ends of the cell sleeve 200 coupled by the taping member 600 may be ends of different cell sleeves 200 (e.g., as shown in FIG. 6) or different ends of the same cell sleeve 200.

As shown in FIGS. 5 and 6, the taping member 600 may be coupled to ends of a plurality of cell sleeves 200. That is, a plurality of cell sleeves 200 may be taped together by the same taping member 600. For example, the taping member 600 may be coupled to lower ends of two cell sleeves 200 stacked in the left and right directions. That is, the left end of the taping member 600 may be adhered to the lower end of a left cover 200L, and the right end of the taping member 600 may be adhered to the lower end of a right cover 200R, as shown in FIGS. 5 and 6. As shown in FIGS. 5 and 6, the left cover 200L and the right cover 200R may include a first side cover 220 at the left side and a second side cover 220 at the right side, respectively. For example, the left end of the taping member 600 may be adhered to a left surface of the first side cover 220 of the left cover 200L, and the right end of the taping member 600 may be adhered to a right surface of the second side cover 230 of the right cover 200R, as shown in FIGS. 5 and 6. Accordingly, heat or gas generated from the battery cells 102 may be vented through the open portions where the taping member 600 may not cover.

Additionally or alternatively, the taping member 600 may be coupled to an end of a single cell sleeve 200. That is, a single cell sleeve 200 may be taped by the same taping member 600. For example, as shown in FIG. 2(a), the taping member 600 may be coupled to a lower portion of one cell sleeve 200. That is, the taping member 600 may be coupled between different ends of one cell sleeve 200. For example, in a single cell sleeve 200, the first side cover 220 may be located at the left side and the second side cover 230 may be located at the right side, as shown in FIG. 2(a). For example, the taping member 600 may have a left end attached to the left surface of the first side cover 220 and a right end attached to the right surface of the second side cover 230.

The taping member 600 may be located at the outer side or end of the pouch-type battery cell 102 that is not surrounded by the cell sleeve 200. For example, in the embodiment of FIGS. 5 and 6, the cell sleeve 200 may be configured to expose the lower end of the pouch-type battery cell 102 to the outside without surrounding the same. In this case, the taping member 600 may be attached to the lower end of the cell sleeve 200 that does not surround the pouch-type battery cell 102 but expose the same to the outside.

For example, the taping member 600 may be configured to couple at least one side of one cell unit of a cell assembly 100. For example, as shown in FIG. 6, two cell sleeves 200 may be included in one cell unit of the cell assembly 100. In embodiments, the cell assembly 100 may include a cell unit U2 including two battery cells 102, as shown in FIG. 6, but is not limited there to. In addition, these two cell sleeve 200 may be coupled to each other by one or more connector (bus bar) assemblies 700. In one embodiment, the taping member 600 may be attached by coupling one ends, particularly the lower ends, of the two cell sleeves 200, as shown in FIG. 6. In addition, a plurality of taping members 600 may be included in one cell unit U2. For example, as shown in FIGS. 5 and 6, in order to couple the lower ends of the two cell sleeves 200, three taping members 600 may be disposed to be spaced apart in the front and rear direction (X-axis direction in the drawing), but is not limited thereto. Here, the front and rear direction may be a horizontal direction orthogonal to the stacking direction of the pouch-type battery cells 102.

Accordingly, the ends of the cell sleeves 200 is prevented from being separated in the cell unit U2. For example, when the first side cover 220 and the second side cover 230 of the cell sleeve 200 are taped by the taping member 600 from the bottom, the first side cover 220 and the second side cover 230 is prevented from being separated to both sides. Therefore, the accommodation state of the cell sleeve 200 and the pouch-type battery cell 102 inside the pack case 300 may be stably maintained. Accordingly, the self-standing configuration of the cell sleeve 200 may be stably maintained.

The cell assembly 100 as shown in FIG. 6 may include a plurality of cell sleeves 200, each including the pouch-type battery cell 102, the connector (bus bar) assembly 700, and the taping member 600, that may be accommodated in the pack case 300 in a stacked form. For example, the cell assembly 100 may be arranged to be stacked side by side in the horizontal direction in the inner space of the lower case 320, as shown in FIG. 1. For example, the plurality of cell assemblies 100 may be stacked so that the surfaces of the cell sleeves 200 may face each other. In one embodiment, the cell sleeves 200 may be arranged to be stacked in the left and right direction such that the first side cover 220 and the second side cover 230 face each other. Also, the cell assemblies 100 may be stacked in the front and rear direction. In one embodiment, the plurality of cell units of a cell assembly 100 may be stacked such that the electrode leads 110 protruding in the front and rear directions in each cell units face each other. Accordingly, the space efficiency may be further improved by removing a module case of the battery module or the like.

The cell sleeve 200 may be formed by bending a plate. For example, the shape of the cell sleeve 200 may be configured to surround one or more pouch-type battery cells 102. The shape of the cell sleeve 200 may be formed by bending both ends of a single plate in the same direction. As shown in FIG. 2, the upper cover 210, the first side cover 220 and the second side cover 230 may be may be made from a single plate. Accordingly, multiple components or parts of the cell sleeve 200 may be manufactured integrally.

In one embodiment, each component or part of a cell sleeve 200 may be distinguished by bent portions. For example, two bent portions may be formed from one plate. In addition, based on these two bent portions, the upper cover 210, the first side cover 220 and the second side cover 230 may be distinguished. In one embodiment, the central portion of one plate may form the upper cover 210, and both sides of the plate may be bent or folded in the lower direction relative to the upper cover 210 to form the first side cover 220 and the second side cover 230. The configuration of forming a bent portion from a single plate to configure the cell sleeve 200 may be implemented in various ways, such as pressing or rolling.

According to aspects of the present disclosure, the cell sleeve 200 may be manufactured in a simple and efficient manner Accordingly, the manufacturing cost and/or time for the battery pack 10 may be reduced. In addition, according to aspects of the present disclosure, the mechanical strength or rigidity of the cell sleeve 200 may be secured to be high. Accordingly, the heat conduction performance through the cell sleeve 200 may be further improved, so that the cooling performance may be further improved.

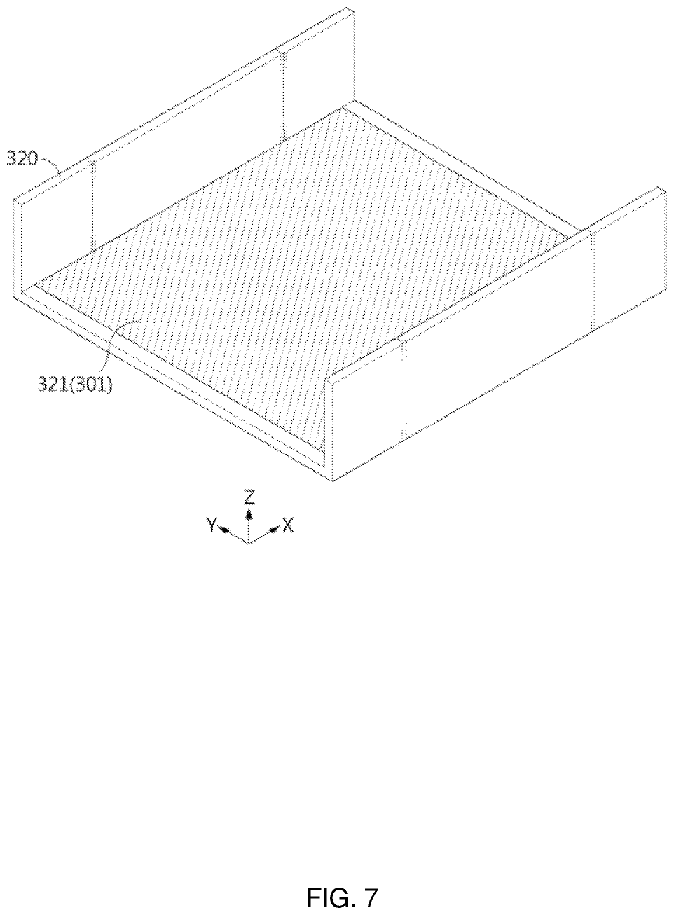

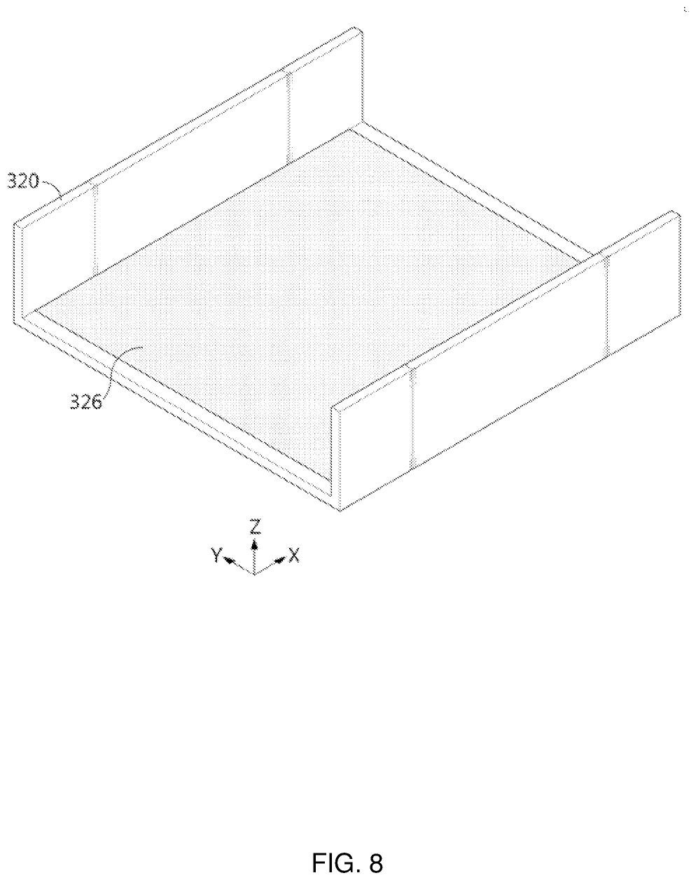

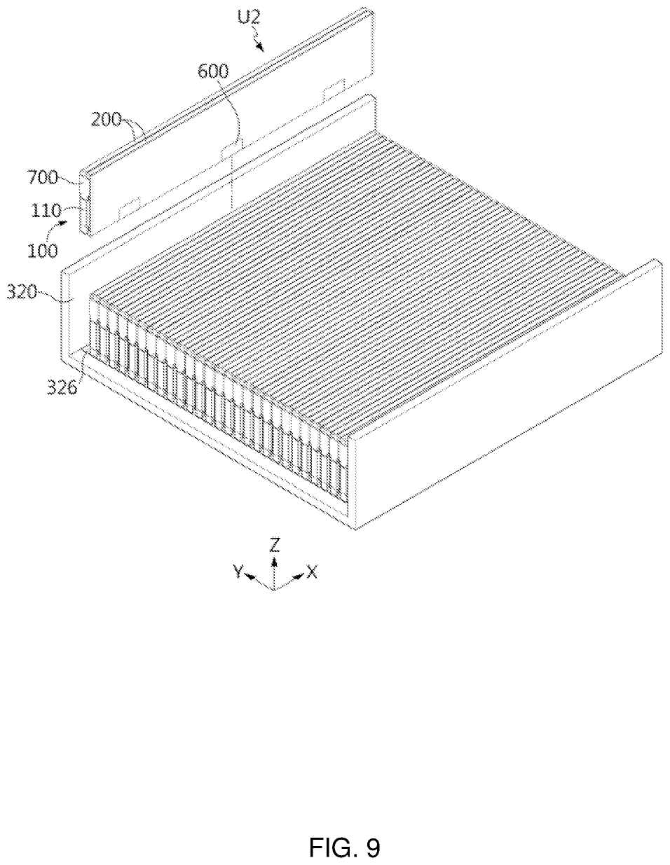

FIGS. 7 to 9 illustrate partial perspective views schematically showing a part of the battery pack according to an embodiment of the present disclosure. FIG. 7 shows a diagram showing a heatsink 301 that may be provided at the lower case 320 of the battery pack 10, and FIG. 8 shows a diagram showing a thermal resin 326 may be applied to the heatsink 301 of FIG. 7. In addition, FIG. 9 shows a perspective view schematically showing a plurality of cell assemblies 100 of FIG. 6 that may be stacked in the inner space of the lower case 320 of FIG. 8.

Referring back to FIG. 7, the pack case 300 may include a heatsink 301. In addition, the plurality of pouch-type battery cells 102 to which the cell sleeve 200 is coupled may be thermally coupled to the heatsink 301. For example, as shown in FIG. 7, the lower case 320 of the pack case 300 may include a lower heatsink 321. In addition, as shown in FIG. 9, a plurality of cell assemblies 100 (or U2) may be directly seated or mounted on the upper surface of the lower heatsink 321. For example, the cell sleeve 200 and the pouch-type battery cell 102 provided to each cell unit U2 may be seated or mounted with the lower ends thereof being in direct contact with the upper portion of the lower heatsink 321 in a state of standing in the upper and lower direction.

In one embodiment, a thermal resin may be interposed between the heatsink 301 and the plurality of pouch-type battery cells 102. For example, referring to FIG. 8, a thermal resin 326 may be applied to the upper surface of the lower heatsink 321 (not shown in FIG. 8 for clarify of illustration and explanation). In addition, as shown in FIG. 9, a plurality of cell units U2, namely a plurality of pouch-type battery cells 102 and a plurality of cell sleeves 200, may be seated or mounted on the upper surface of the lower heatsink 321 to which the thermal resin 326 is applied as described above.

In one embodiment, the thermal resin 326 may be made of a material that conducts heat and has an adhesive property. The thermal resin 326 may transfer heat to the heatsink 301 so that the heat generated at the pouch-type battery cell 102 is dissipated through the heatsink 301. Moreover, since the thermal resin 326 has an adhesive property, the thermal resin 326 may mechanically or physically couple the cell sleeve 200 and/or the pouch-type battery cell 102 to the heatsink 301.

In one embodiment, the plurality of pouch-type battery cells 102 to which the cell sleeve 200 is coupled may be directly seated or mounted on the upper surface of the lower heatsink 321 to which the thermal resin 326 is applied, as shown in FIG. 9. For example, a plurality of cell units U2 may be stably coupled and fixed to the upper surface of the lower heatsink 321 by the thermal resin 326. For example, the pouch-type battery cell 102 and cell sleeve 200 included in each cell unit U2 may be formed such that the length of each of the cell units U2 in the upper and lower direction (Z-axis direction) may be longer than the width in the left and right direction (Y-axis direction). Therefore, the pouch-type battery cell 102 and the cell sleeve 200 may be seated or mounted in a standing state, namely in an upright state, on the upper surface of the lower heatsink 321, as shown in FIG. 9. Accordingly, the thermal resin 326 may allow the standing state of the pouch-type battery cell 102 and the cell sleeve 200 to be maintained more stably.

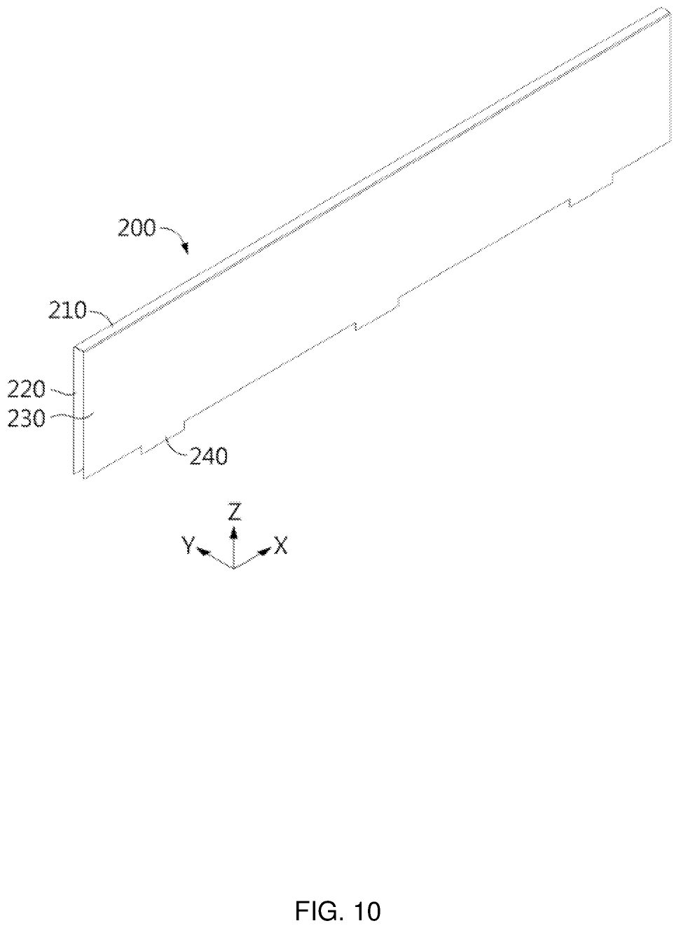

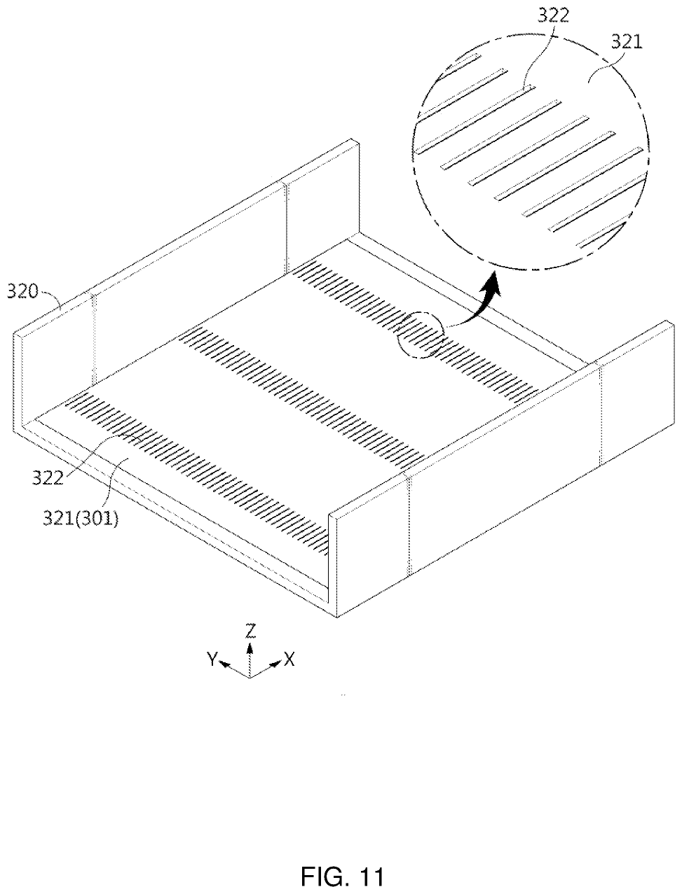

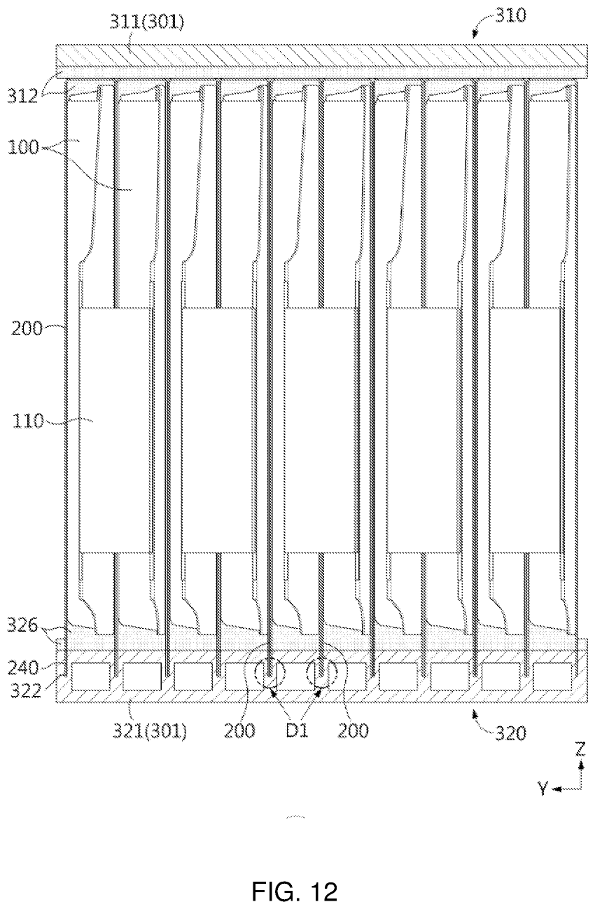

FIGS. 10 and 11 are perspective views schematically showing a cell sleeve 200 and a pack case 300, respectively, according to embodiments of the present disclosure. Also, FIG. 12 is a cross-sectional view schematically showing a part of a battery pack 10 including the cell sleeve 200 and the pack case as shown in FIGS. 10 and 11. Referring to

FIGS. 10 to 12, the cell sleeve 200 may be configured such that at least one end thereof is fitted to the pack case 300. For example, as indicated by D1 in FIG. 12, the lower ends of each cell sleeve 200 may be partially fitted into the lower case 320, thereby being fastened and fixed thereto.

For example, as shown in FIG. 10, the cell sleeve 200 may have a protrusion 240 formed on the lower end thereof. The protrusion 240 may be shaped to extend relatively longer in the lower direction from the lower end of the cell sleeve 200, as shown in FIG. 10.

In one embodiment, the cell sleeve 200 may include a plurality of protrusions 240. For example, as shown in FIG. 10, the protrusions 240 may be provided to the first side cover 220 and the second side cover 230. For example, as shown in FIG. 10, a plurality of protrusions 240, for example three protrusions 240, may be provided at the lower end of the second side cover 230 along the front and rear direction.

Referring to FIG. 11, in one embodiment, the pack case 300 may have a coupling groove 322 configured to allow the protrusion 240 of the cell sleeve 200 to be inserted into the coupling groove 322. For example, the coupling groove 322 may be formed at a position and may have a shape corresponding to the protrusion 240. For example, as shown in FIG. 11, the coupling groove 322 may be formed at a position and may have a shape corresponding to the protrusion 240 of the cell sleeve at the bottom surface of the lower case 320 on which the cell sleeve 200 may be seated or mounted. Moreover, one or more protrusions 240 may be fitted into at least one coupling groove 322. For example, two protrusions 240 may be inserted into the coupling groove 322 of the central portion as indicated by D1 in FIG. 12. In one embodiment, in the pack case 300, one protrusion 240 may be inserted into the coupling groove 322 located at the outermost side in the stacking direction of the cell sleeve 200. For example, as shown in FIG. 12, one protrusion 240 may be inserted into each of the coupling grooves 322 positioned at the leftmost and rightmost sides among the plurality of coupling grooves 322 arranged in the left and right direction.

In one embodiment, the pack case 300 may include a heatsink 301. In addition, the cell sleeve 200 may be seated or mounted on and coupled to the heatsink 301. Accordingly, the coupling groove 322 of the pack case 300 may be formed at the heatsink 301. For example, as shown in FIGS. 11 and 12, a plurality of coupling grooves 322 may be formed at the lower heatsink 321, and the lower protrusions 240 of the cell sleeve 200 may be inserted into the coupling grooves 322.Accordingly, the coupling between the cell sleeve 200 and the pack case 300 is further improved. Therefore, even in a situation where vibration or shock is applied to the battery pack or swelling occurs at the pouch-type battery cell 102, the stacking state of the cell sleeve 200 and the pouch-type battery cell 102 accommodated therein may be stably maintained. Accordingly, the cell sleeve 200 is prevented from, for example, moving in the front and rear direction (X-axis direction). Further, the cell sleeve 200 is prevented from, for example, moving in the left and right direction (Y-axis direction), and effectively prevents the first side cover 220 and the second side cover 230 from being separated.

In one embodiment, a thermal resin 326 may be applied to the top surface of the heatsink 301, for example the lower heatsink 321. Additionally or alternatively, the thermal resin 326 may be introduced into the coupling groove 322 of the lower heatsink 321 to further increase the coupling force between the protrusion 240 of the cell sleeve 200 and the lower heatsink 321.

In this embodiment, through the fitting configuration between the cell sleeve 200 and the pack case 300, the assembly position of the cell sleeve 200 inside the pack case 300 may be guided. Accordingly, the assembling property of the battery pack 10 may be further improved.

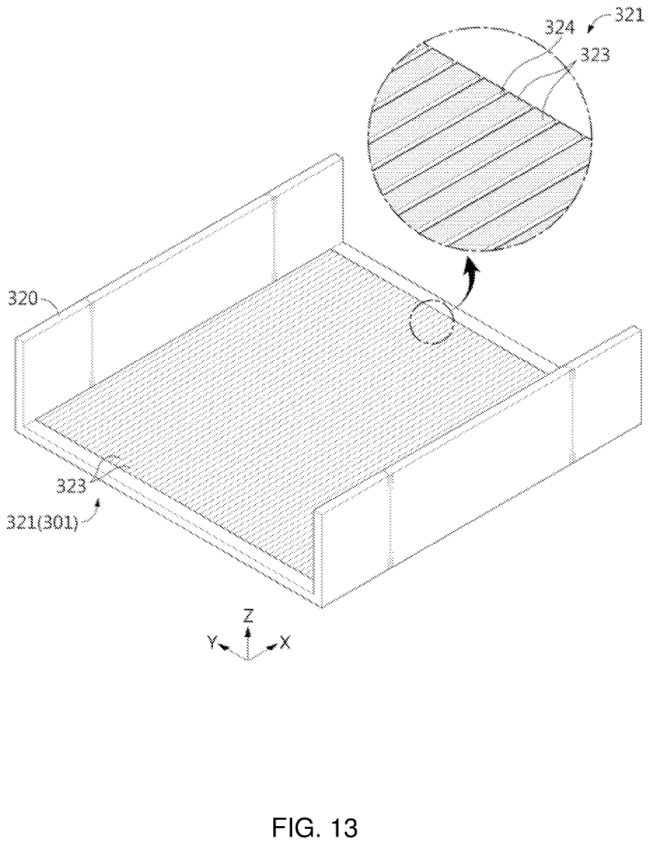

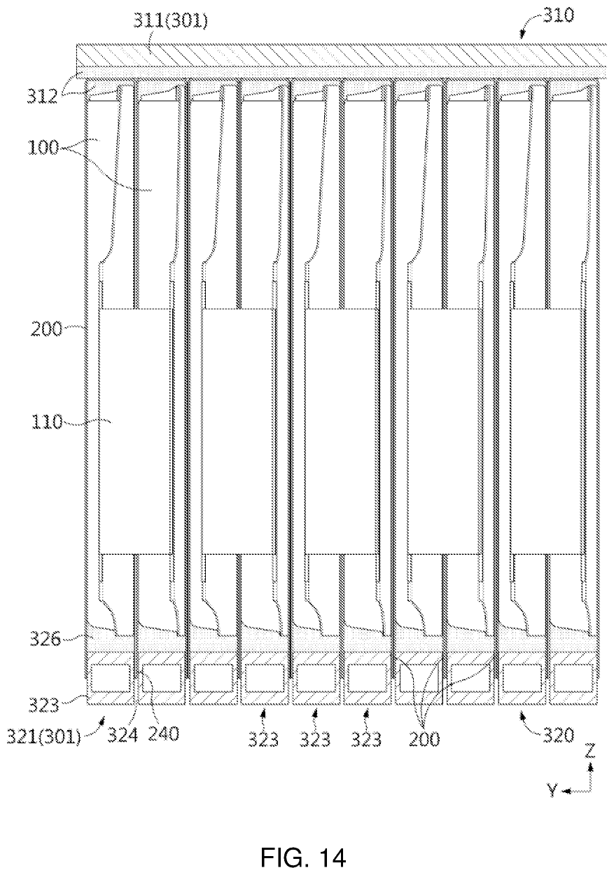

FIG. 13 is a perspective view schematically showing a pack case 300 according an embodiment of the present disclosure. Also, FIG. 14 is a cross-sectional view schematically showing a part of a battery pack 10 including the pack case 300 shown in FIG. 13.

Referring to FIG. 13, the heatsink 301, for example the lower heatsink 321, may include a plurality of heatsink units 323. Here, the plurality of heatsink units 323 may be installed in the pack case 300, for example the lower case 320, spaced apart from each other to have a predetermined interval 324.

For example, the plurality of heatsink units 323 may be arranged along the stacking direction of the plurality of pouch-type battery cells 102. For example, as shown in FIGS. 13 and 14, the plurality of pouch-type battery cells 102 may be stacked in the left and right direction (Y-axis direction). Accordingly, the plurality of unit heatsinks 323 may be arranged in the left and right direction in a state of being spaced apart from each other by a predetermined interval 324.

As shown in FIG. 14, the plurality of heatsink units 323 may be mounted to the battery case 300. For example, although not shown in FIG. 14 for clarity of illustration and description, the lower case 320 may include a bottom plate on which the plurality of unit heatsinks 323 may be seated or mounted, under the plurality of heatsink units 323.

According to aspects of the present disclosure, heat propagating through between heatsink 301 may be prevented or reduced. That is, when heat is generated from a pouch-type battery cell 102 and is transferred to a corresponding heatsink units 323, since the heatsink units 323 are spaced apart from each other, heat transferring to other heatsink units 323 is prevented or reduced. Accordingly, the problem such as thermal runaway propagation between the battery cells 102 may be prevented or reduced more effectively.

In some embodiments, the plurality of cell sleeves 200 may be spaced apart from each other. Alternatively, a heat insulating pad or a flame suppression pad may be interposed between at least a part of the plurality of cell sleeves 200. For example, the end of the cell sleeve 200 may be configured to be interposed in a separated space between the plurality of heatsink units 323. As shown in FIG. 10, when the protrusion 240 is formed at the lower side of the cell sleeve 200, the protrusion 240 of the cell sleeve 200 may be coupled to the interval 324 between the plurality of heatsink units 323, such as the separated space, as shown in FIG. 14. Additionally or alternatively, even if the protrusion 240 is not provided on the cell sleeve 200, the lower end of the cell sleeve 200 as indicated by C1 in FIG. 2 may be fitted into the interval 324 between the heat sink units 323, arranged in the front and rear direction.

In one embodiment, a part of the cell sleeve 200 may be fitted into the separated space between the plurality of unit heatsinks 323 as described above, and the coupling force between the pack case 300 having the heatsink units 323 and the cell sleeve 200 may be stably secured.

Still referring to FIG. 14, in one embodiment, a thermal resin 326 may be applied to the heatsink 301. For example, the thermal resin 326 may be introduced into the interval 324 between the plurality of unit heatsinks 323. Accordingly, the coupling force between the cell sleeve 200 and the heatsink 301 may be further increased.

As shown in FIGS. 12 and 14, a unit of heatsink 301 may include two heatsinks, for example, an upper heatsink 311 and a lower heatsink 321. The upper heatsink 311 may be disposed on the cell sleeve 200. Moreover, the upper heatsink 311 may be positioned on the upper cover 210 of the cell sleeve 200 to directly or indirectly contact the upper cover 210. In addition, the lower heatsink 321 may be disposed under the cell sleeve 200. Moreover, the lower heatsink 321 may be in contact with the lower end of the cell sleeve 200. The thermal resin 312 may be interposed between the cell sleeve 200 and the upper heatsink 311 and/or between the cell sleeve 200 and the pouch-type battery cell 102 to be coupled to each other. In addition, the thermal resin 326 may be interposed between the pouch-type battery cell 102 and the lower heatsink 321 to couple them together.

Accordingly, the cooling performance of the battery pack may be further improved. For example, the heat generated from the pouch-type battery cell 102 may be moved to the upper side and the lower side, for example, toward the upper heatsink 311 and the lower heatsink 321, and discharged. Accordingly, a dual or multiple cooling of the battery pack may be easily implemented.

Although the thermal resin 312 may be provided along with the heatsink 301 in the pack case 300, as described above, thermal resin may be utilized in the pack case 300 not including the heatsink 301. That is, the thermal resin may be provided on the inner surface of the pack case 300. For example, the thermal resin may be provide at locations corresponding to the mounting locations of the cell assembly 100. Accordingly, a lower portion of the cell assembly 100 may be adhered or coupled to the inner surface of the pack case 300. Further, thermal resin may be provided in the cell sleeve 200. That is, the thermal resin may be provided between an inner surface of a cell sleeve 200 and an outer surface of a battery cell 102.

The battery pack 10 according to the present disclosure may further include a battery management system 400 as shown in FIG. 1. The battery management system (BMS) 400 may be mounted in the inner space of the pack case 300, and may be configured to control charging/discharging operation or data transmission/reception operation of the cell assembly 100 as a whole. The battery management system 400 may be provided in a pack unit, rather than a module unit. For example, the battery management system 400 may be provided to control the charging/discharging state, the power state, the performance state, or the like of the pouch-type battery cell 102 through a pack voltage and a pack current. The battery pack 10 according to the present disclosure may further include a battery disconnect unit 500, as shown in FIG. 1. The battery disconnect unit (BDU) 500 may be configured to control electrical connection of the cell assemblies 100 in order to manage power capacity and functions of the battery pack 10. To this end, the battery disconnect unit 500 may include a power relay, a current sensor, a fuse, and the like. The battery disconnect unit 500 may also be provided in a pack unit, rather than a module unit, and various disconnection units.

In addition, the battery pack 10 according to the present disclosure may further include various components of a battery pack. For example, the battery pack 10 according to an embodiment of the present disclosure may further include a manual service disconnector (MSD) capable of shutting off power by an operator manually disconnecting a service plug.

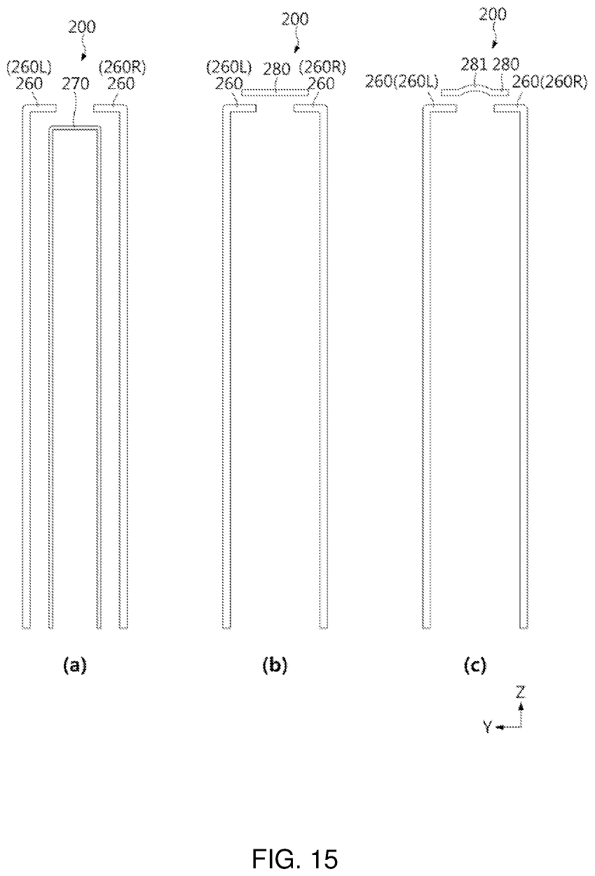

In accordance with the forgoing embodiments, the cell sleeve 200 may have an substantially n-shape and have an integrally manufactured form, but the present disclosure is not necessarily limited to this embodiment. That is, the cell sleeve 200 may be manufactured in various other forms or methods. This will be described in more detail with reference to FIG. 15.

FIG. 15 is an exploded perspective view schematically showing the cell sleeves 200 according to still another various embodiments of the present disclosure.

Referring to FIG. 15(a), the cell sleeve 200 may include two unit members 260. Here, each unit member 260 may be formed in an L-shape. The unit member 260 may be referred to as an L pin, in view of its shape characteristic. For example, the two unit members 260 may be configured such that the upper ends thereof are bent in opposite directions toward each other. That is, the upper end of the left L pin 260L may be bent in the right direction, and the upper end of the right L pin 260R may be bent in the left direction. In addition, the two L-shaped unit members 260L, 260R may be coupled with each other to form an n-shaped cell sleeve 200 similarly to the cell sleeve 200 shown in FIG. 2. In one embodiment, the left L pin 260L may constitute the left and first side cover 220 of the upper cover 210, and the right L pin 260R may constitute the right and second side cover 230 coupled to the upper cover 210.

In addition, as shown in FIG. 15(a), the cell sleeve 200 may further include an insulation member 270. The insulation member 270 may be made of an electrically insulating material and may be provided to the inner surface of the cell sleeve 200 in which the pouch-type battery cell 102 is accommodated. In particular, the insulation member 270 may have an adhesive layer on at least one side thereof and may be adhered to the inner surface of the cell sleeve 200. Moreover, when the two L pins 260L, 260R are coupled with each other to form one cell sleeve 200, the insulation member 270 may support or reinforce the coupling force between the two L pins 260L, 260R. In addition, the insulation member 270 may be made of a material having heat resistance. For example, the insulation member 270 may be configured in the form of a heat-resistant tape in which an adhesive is applied to the surface of a ceramic sheet having heat resistance.

According to aspects of the present disclosure, since a single plate needs to be bent only once, the configuration of providing the cell sleeve 200 in an n-shape to surround the pouch-type battery cell 102 may be more easily achieved. For example, according to one embodiment, in order to form the cell sleeve 200, there is no need to perform a deep pressing process or the like to a plate made of a material with high strength such as steel. In addition, according to one embodiment, the springback and flatness of the cell sleeve 200 may be excellently achieved. Accordingly, the cell sleeve 200 may be more resistant to heat or flame.

Referring to FIG. 15(b), the cell sleeve 200 may further include an upper plate 280 in addition to the two unit members 260 formed in an L-shape. Moreover, the upper plate 280 may be formed in a flat shape, and may be configured to be padded on top of the upper bent portions of the two L pins 260L, 260R. In addition, both ends of the upper plate 280 may be respectively joined to the two L pins 260L, 260R to couple them to each other. Here, the upper plate 280 may form all or a part of the upper cover 210 of the n-shaped cell sleeve 200 as described above with reference to FIG. 2.

According to one embodiment, the flatness of the cell sleeve 200 may be excellent. For example, in this embodiment, since the upper plate 280 is located on the upper portion of the cell sleeve 200 in a flat shape, the flatness of the part corresponding to the upper cover 210 may be higher. Accordingly, the volume of the battery pack may be reduced, the energy density may be increased, and the cooling performance at the upper side may be further improved.

Referring to FIG. 15(c), the cell sleeve 200 may include two unit members 260 formed in an L-shape similar to the embodiment of FIG. 15(b) and an upper plate 280. However, in FIG. 15(c), unlike the embodiment of FIG. 15(b), the upper plate 280 may have a convex portion 281. For example, the convex portion 281 may have a shape protruding from the upper plate 280 in the upper direction (+Z-axis direction).

Accordingly, to the cell sleeve 200 may reduce or prevent any damage due to the occurrence of swelling in the pouch-type battery cell 102. For example, when swelling occurs at the pouch-type battery cell 102 accommodated in the accommodation space inside the cell sleeve 200 configured as shown in FIG. 15(c), the distance between the left L pin 260L and the right L pin 260R is at least partially increased. That is, the convex portion 281 of the upper plate 280 may be stretched or its convexity may be reduced. Accordingly, the stress generated at the cell sleeve 200, particularly the upper end thereof, may be reduced.

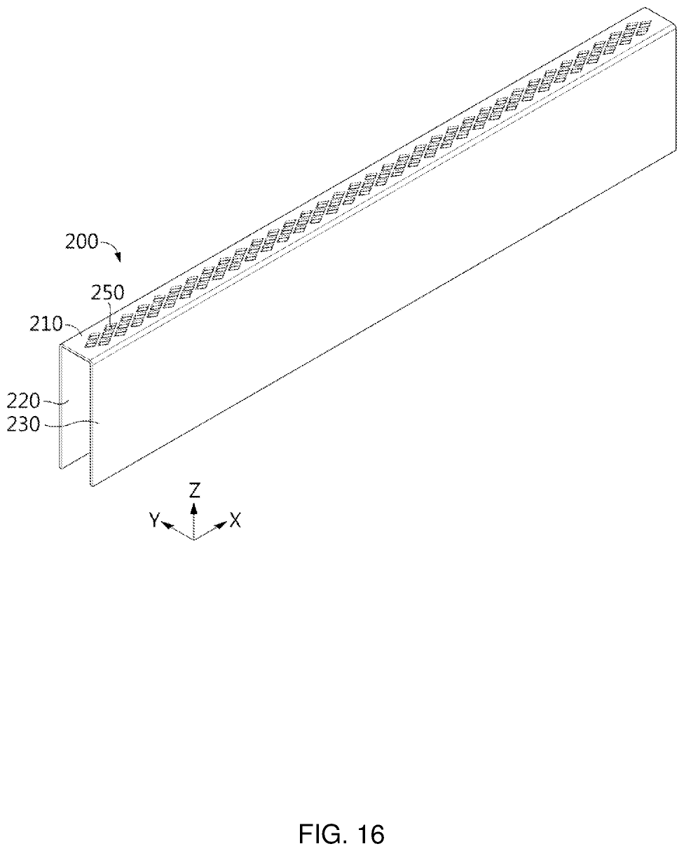

FIG. 16 is a perspective view schematically showing a cell sleeve 200 according to an embodiment of the present disclosure.

Referring to FIG. 16, in the cell sleeve 200, a perforation hole(s) 250 may be formed. The perforation hole(s) 250 may be configured to discharge a flame or gas generated in the pouch-type battery cell 102 surrounded by the cell sleeve 200. The perforation hole(s) 250 may be formed at various positions of the cell sleeve 200. For example, the perforation hole(s) 250 may be formed in the upper cover 210 as shown in FIG. 16. In addition, the perforation hole(s) 250 may be formed in various shapes in the cell sleeve 200. For example, the perforation hole(s) 250 may be formed in a diamond or rhombus shape, as shown in FIG. 16. However, the perforation hole(s) 250 may be formed in other various shapes, for example a rectangular or circular shape, and is not limited thereto.

In addition, a plurality of perforation holes 250 may be formed in one cell sleeve 200. For example, the plurality of perforation holes 250 may be respectively arranged in the left and right direction and the front and rear direction in the upper cover 210. In addition, the perforation holes 250 may be formed in a grid or mesh shape, but is not limited thereto.

In particular, the perforation hole 250 of the cell sleeve 200 may be configured to be widened when swelling occurs at the pouch-type battery cell 102. For example, as shown in FIG. 16, when the pouch-type battery cell 102 accommodated in the cell sleeve 200 swells, the first side cover 220 and the second side cover 230 may receive a force in a direction to be spaced apart from each other. Accordingly, when one or more perforation holes 250 formed in the upper cover 210 are configured to be widened, the stress applied to the cell sleeve 200 may be reduced.

Further, through the perforation hole 250, a flame and gas discharge effect and a swelling response effect may be achieved together. Furthermore, when flame and gas are discharged through the perforation hole 250, the discharge direction may be controlled. Moreover, when the perforation hole 250 is formed in the upper cover 210, as shown in FIG. 16, the gas or flame may be discharged toward the upper side, rather than toward other pouch-type battery cells 102 stacked in the horizontal direction. Accordingly, propagation of gas or flame between the cells may be further prevented.

In one embodiment, the perforation hole 250 of the cell sleeve 200 may be configured to open when the cell assembly 100 swells. That is, the perforation hole 250 may be closed during normal operation. However, when pressure is applied to the cell sleeve 200 in the event of swelling of the cell assembly 100, the perforation hole 250 may be widened or opened. Accordingly, since the perforation hole 250 is closed during normal operation of the cell assembly 100, the battery cells 100 may be projected by the cell sleeve 200. For example, water or dust may be prevented or reduced from entering inside of the cell sleeve 200. Further, any gas produced due to potential thermal runaway may be efficiently and quickly vented through the perforation hole 250 on the cell sleeve 200.

Additionally, when a fire-extinguishing agent is present on the upper part of the cell sleeve 200 or the upper part of the battery pack 10, the venting configuration in the upper direction may be more effective in suppressing fire. For example, when a fire-extinguishing tank containing the fire-extinguishing agent is disposed on the upper part of the cell sleeve 200, if a flame or gas is discharged to the upper part of the cell sleeve 200, the fire-extinguishing agent may be discharged from the fire-extinguishing tank to prevent or delay the fire.

In one embodiment, when the perforation hole 250 is formed in the cell sleeve 200 as shown in FIG. 16, the thermal resin 312 may be interposed between the cell sleeve 200 and the pouch-type battery cell 102 as shown in FIGS. 12 and 14. In this case, it is possible to supplement the safety deterioration problem, such as the exposure of the pouch-type battery cell 102 to the outside through the perforation hole 250.

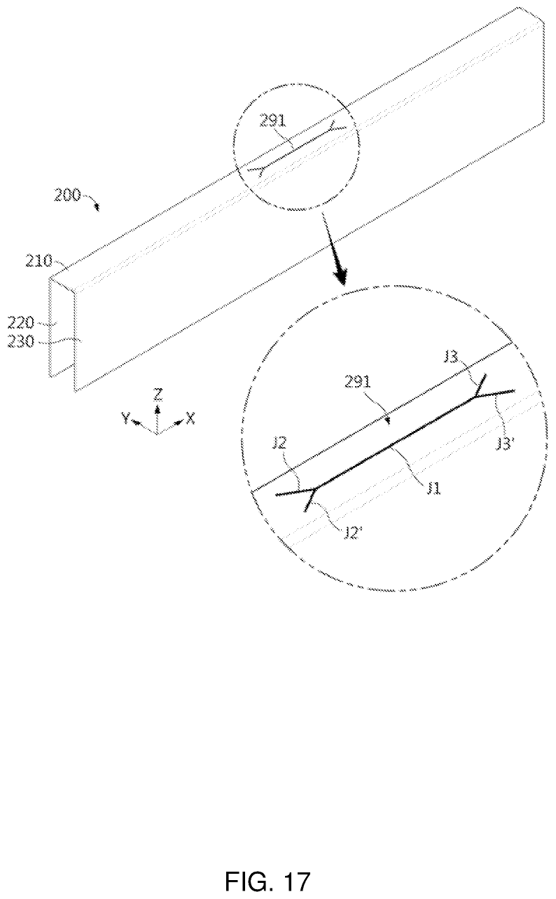

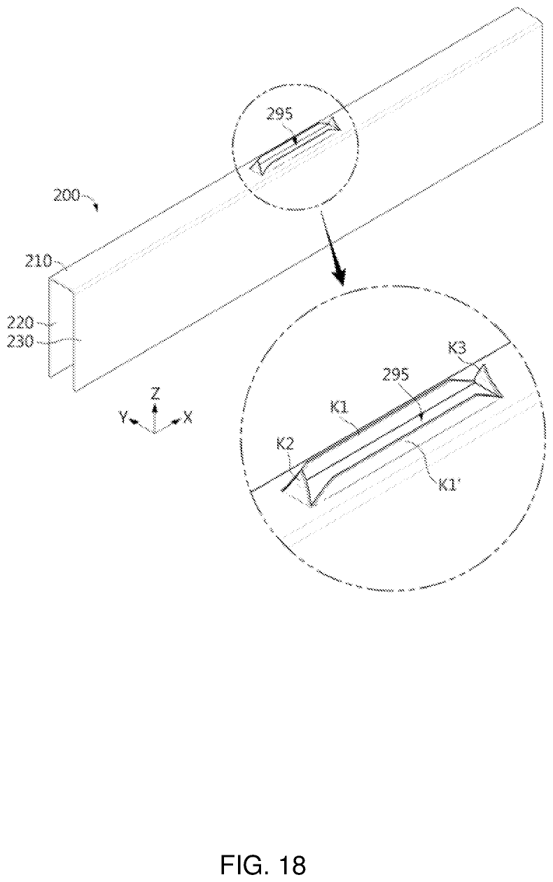

FIG. 17 is a perspective view schematically showing a cell sleeve 200 according to an embodiment of the present disclosure. Also, FIG. 18 is a perspective view schematically showing the cell sleeve 200 of FIG. 17 that is deformed due to gas discharge or the like.

Referring to FIG. 17, the cell sleeve 200 may have a cut portion 291. The cut portion 291 may be configured to discharge a flame or gas generated in the pouch-type battery cell 102. For example, the cut portion 291 may be formed in the form of cutting a portion of the cell sleeve 200 with a sharp object such as a knife. For example, the cut portion 291 may be provided in such a way that a knife cuts through the cell sleeve 200 in a linear fashion. Alternatively, the cut portion 291 may be provided to form a notch without completely perforating the cell sleeve 200. The cut portion 291 may be formed in a substantially straight shape along the horizontal extension direction of the cell sleeve 200, and an end of the cut portion in the extension direction may be branched. In one embodiment, the cut portion 291 may be a slit.

For example, as shown in FIG. 17, the cut portion 291 may be provided in the X-axis direction. The cut portion 291 may include a center cut line J1. Further, the cut portion 291 may include cut lines J2, J2′, J3, and J3′. For example, the cut lines J2 and J2′ may be provide don one end of the center cut line J1, and the cut lines J3 and J3′ may be provided on the opposite end of the center cut line J1, as shown in FIG. 17.

In addition, when gas or flame is discharged from the pouch-type battery cell 102 accommodated in the cell sleeve 200, the cell sleeve 200 may be deformed as shown in FIG. 18. Of course, the modified form of FIG. 17 and/or FIG. 18 is only an example, and the cell sleeve 200 may be modified into various other forms according to the shape of the cut portion 291 or the discharge pressure of gas or flame.

In one embodiment, in a state where the cut portion 291 is formed on the cell sleeve 200 as shown in FIG. 17, if a flame or gas is generated in the battery cell 102 due to thermal runaway of the battery cell 102, the pressure inside the battery cell 102 may increase. In addition, if the internal pressure increase reaches a certain level or above, as shown in FIG. 18, the cut portion 291 is widened, and the flame or gas may be discharged through the widened area 295 of the cut portion 291.

Accordingly, when gas or flame occurs, it is possible to smoothly and quickly discharge the gas or flame to the outside without exposing the battery cell 102 accommodated in the cell sleeve 200 to the outside.

The cut portion 291 may be formed at various parts of the cell sleeve 200, for example at the upper side of the cell sleeve 200 as shown in FIGS. 17 and 18. If the cut portion 291 is formed at the upper side of the cell sleeve 200, for example the upper cover 210, as described above, the flame or gas may be induced to be discharged in a preset upper direction.

For example, even if thermal runaway occurs at any one battery cell 102, the flame or gas generated in the battery cell 102 may be discharged only through the upper side of the cell sleeve 200. Accordingly, the flame or gas may not propagate to other battery cells 102 disposed adjacent to the side of the battery cell 102 in which the thermal runaway occurs. That is, even if thermal runaway occurs at one battery cell 102, the effect of the thermal runaway on other battery cells 102 may be minimized

Referring to FIG. 18, the cut portion 291 of the cell cover 200 may become deformed when gas is vented through the cut portion 291 due to the pressure exerted by the gas. Accordingly, the cut portion 291 may become the widened area 295. For example, as shown in FIG. 17, when the cut portion 291 includes slits on both ends of the cut portion 291, one or more parts of the cut portion 291 may become deformed. For example, as shown in FIG. 18, the cut portion 291 as shown in FIG. 17 may become deformed having 4 modified parts (K1, K1′, K2, K3). The left modified part K1 may correspond to the cut lines J1, J2, and J3, and the right modified part K1′ may correspond to the cut lines J1, J2′, and J3′. Further the front modified part K2 may correspond to the cut lines J2 and J2′, and the back modified part K3 may correspond to the cut lines J3 and J3′. For example, the 4 modified parts K1, K1′, K2, and K3 may be provided on the upper cover 20 of the cell sleeve 200, as shown in FIG. 18. Accordingly, the plurality of modified parts (K1, K1′, K2, K3) may effectively vent gas and prevent propagation of the gas to other cell sleeves 200. For example, the left modified part K1 may effectively guide the flow of the venting gas in the +Z axis direction, while preventing the flow of the venting gas to the left direction. Additionally, the right modified part K1′ may effectively guide the flow of the venting gas in the +Z axis direction, while preventing the flow of the venting gas to the right direction. Accordingly, heat or flames may be prevented from propagating between the cell assemblies that may be stacked in the left and right directions.

In one embodiment, the battery pack 10 according to the present disclosure may further include a heat insulating material (not shown for clarity of illustration and explanation) or various injection-molded materials (not shown for clarity of illustration and explanation) inside the cell sleeve 200 or in the form of replacing a part of the cell sleeve 200. For example, the cut portion 291, the perforation hole(s) 250, or the like may be formed at the insulating material or the injection-molded materials. Moreover, if an insulating material or an injection-molded material is provided inside the cell sleeve 200, the cut portion or the perforation hole of the insulation material or the injection-molded material may be formed to have a position or shape corresponding to the cut portion 291 or the perforation hole(s) 250 of the cell sleeve 200.

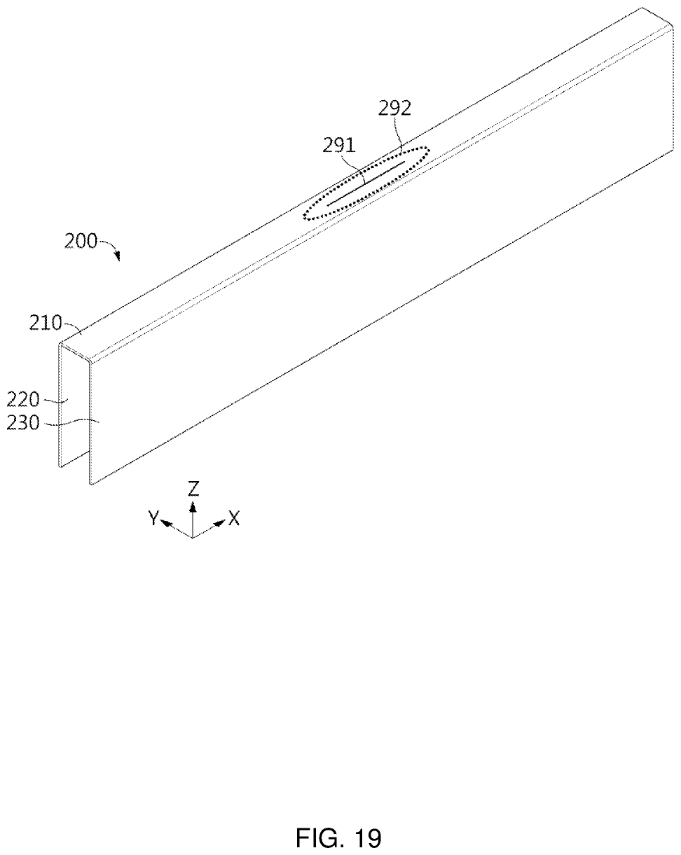

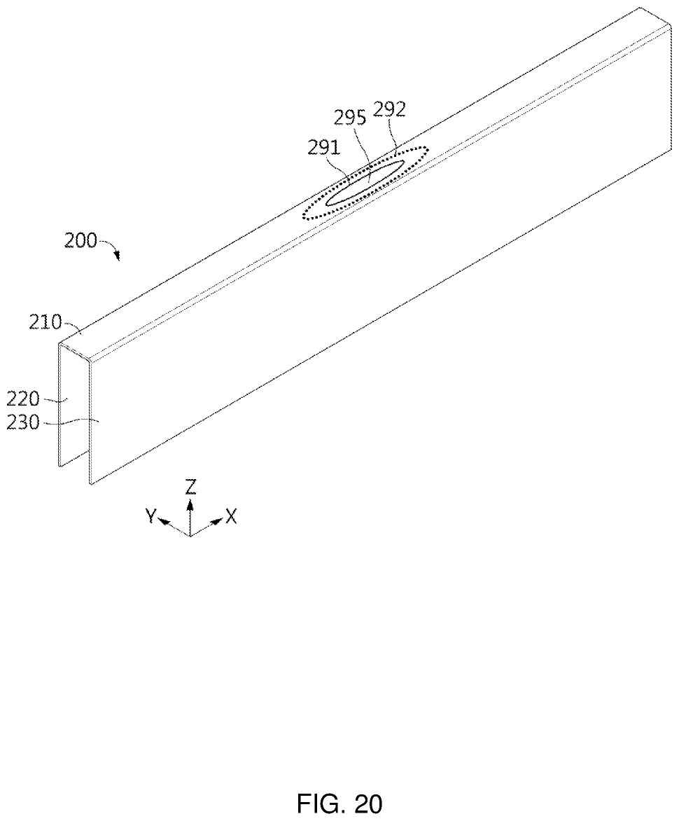

FIG. 19 is a perspective view schematically showing a cell sleeve 200 according to an embodiment of the present disclosure. Also, FIG. 20 is a perspective view schematically showing the cell sleeve 200 of FIG. 19 that is deformed due to gas discharge or the like.

Referring to FIG. 19, a perforated portion 292 may be formed around the cut portion 291. For example, the perforated portion 292 may be formed in a dotted line along the periphery of the cut portion 291. Accordingly, since the perforated portion 292 includes a plurality of holes in the form of a dotted line, when thermal runaway occurs, the flame or gas may be discharged through the perforated portion 292 in the form of a dotted line. In addition, when the gas or flame is discharged, the cut portion 291 may be widened as shown in FIG. 20, and the flame or gas may be discharged through the widened area 295 of the cut portion 291. In one embodiment, the perforated portion 292 may have a hole shape having a small area than the widened area 295 formed by the cut portion 291.

Accordingly, the gas or flame discharged through the cell sleeve 200 may be more quickly and smoothly discharged through the cut portion 291 and the perforated portion 292. Further, when gas or flame is generated, the gas or flame may be discharged primarily through the perforated portion 292. Furthermore, when the gas or flame is expanded to a certain level or more, the gas or flame may be discharged through the cut portion 291 secondarily.

Further, when a relatively small amount of gas is discharged from the cell assembly 100 during an early stage of a thermal runaway, the discharged gas may initially exit out of the cell sleeve 200 through the perforated portion 292. In this example, since the cut portion 291 may not be opened, the widened area 295 may be prevented. However, when the thermal runaway becomes worse and a large amount of gas is discharged, the cut portion 291 may subsequently open to form the widened area 295. Accordingly, the large amount of gas generated from the cell assembly 100 may be fully discharged through the winded area 295. As such, any gas generated inside of the cell sleeve 200 may be vented or discharged quickly and effectively. Accordingly, the cell assembly 100 may be configured to control the venting any gas generated in the cell assembly 100 in multiple steps.

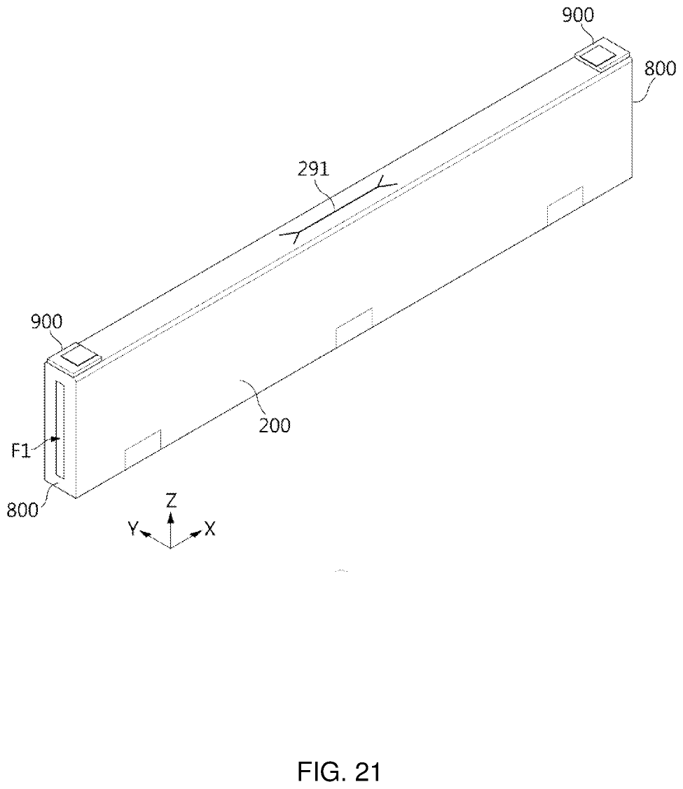

FIG. 21 is a perspective view schematically showing a part of a battery pack according to an embodiment of the present disclosure.

Referring to FIG. 21, the cell assembly 100 according to the present disclosure may further include an end plate 800. The end plate 800 may be provided to at least one side of the cell sleeve 200. In particular, the end plate 800 may be provided to an exposed side among the various sides of the cell sleeve 200. For example, the end plate 800 may be coupled to the openings at the front and rear sides of the cell sleeve 200 where the electrode leads 110 are exposed. Moreover, the end plate 800 may be located at the outer side of the connector (bus bar) assembly 700 in the front and rear direction. In one embodiment, or obtain the electrical insulation between the end plate 800 and the connector assembly 700, electrical insulation material may be provided. Further, the end plate 800 may include material having a good physical strength or rigidity. For example, the end plate 800 may be include a material including plastic and/or metal.

Accordingly, mechanical and electrical safety of the connector (bus bar) assembly 700 may be improved Further, it may be more advantageous in terms of preventing thermal runaway propagation or securing safety for human life by controlling the emission of gas or flame.

As shown in FIG. 21, as indicated by Fl, a discharge hole may be formed in the end plate 800. The discharge hole Fl may induce venting toward the end plate 800 when thermal runaway occurs at the pouch-type battery cell 102 accommodated inside the cell sleeve 200. The discharge hole Fl of the end plate 800 may be formed in various shapes. For example, the discharge hole Fl may be formed in the same shape as the perforation hole 250, the cut portion 291 or the perforated portion 292 of FIGS. 16 to 20.

In addition, the cell assembly 100 according to the present disclosure may further include a cover terminal 900 as shown in FIG. 21. The cover terminal 900 may be electrically connected to the connector (bus bar) assembly 700 and function as an electrode terminal of each battery cell 110 or each cell unit of one or more cell assemblies 100. Therefore, by connecting the cover terminals 900 to each other, a plurality of cell units of one or more cell assemblies 100 may be electrically connected to each other.

For example, the cover terminal 900 may be provided to an outer side of the cell sleeve 200 or the end plate 800. For example, the cover terminal 900 may be located at the upper side of the cell sleeve 200, for example, at the upper cover 210 as shown in FIG. 21. Accordingly, a connection member for connecting the cover terminals 900 of a plurality of cell units of one or more cell assemblies 100 to each other may be located at the upper portion of the cell unit stack to electrically connect the cell units to each other. Alternatively, the cover terminal 900 may be located at a side surface or a lower portion of the cell sleeve 200, and/or at the end plate 800. For example, the cover terminal 900 may be located on an upper portion of the end plate or an upper portion of the connector (or busbar) assembly 700.

According to this embodiment of the present disclosure, a plurality of battery cells 102 or a plurality of cell units may be electrically connected more easily.

In an embodiment including the end plate 800 and/or the cover terminal 900, the electrical lead 110 of the battery cell 102 in the cell sleeve 200 may not be exposed to the outside of the cell sleeve 200. For example, each cell unit of the cell assembly 100 may include a cover terminal 900 that is exposed outside of the cell sleeve 200 to function as terminal to facilitate electrical connection to other cell assemblies 100. The electrical lead 110 may be covered by the end plate 800 and may not be exposed outside of the cell sleeve 200. Alternatively, the connector (or busbar) assembly 700 may include a terminal that is exposed outside of the cell sleeve to function as a terminal to facilitate electrical connection to other cell assemblies 100.

The battery pack according to the present disclosure may further include a separate end cover formed to surround the outer side of the cell sleeve 200. The end cover may be configured to surround one cell sleeve 200 or surround a plurality of cell sleeves 200 at once.

FIG. 22 shows a perspective view schematically showing a vehicle according to an embodiment of the present disclosure. A vehicle V may include the battery pack 10 according to the present disclosure as described above. Here, the vehicle V according to the present disclosure may include, for example, a predetermined vehicle V using electricity as a driving source, such as an electric vehicle or a hybrid electric vehicle. In addition, the vehicle V according to the present disclosure may further include other various components included in a vehicle, such as a vehicle body, a motor, or the like, in addition to the battery pack 10 according to the present disclosure.

In this specification, terms indicating directions such as “upper”, “lower”, “left”, “right”, “front”, and “rear” are used, but these terms are just for convenience of explanation, and it is obvious to those skilled in the art that these terms may vary depending on the location of an object or the position of an observer.

The present disclosure has been described in detail. However, it should be understood that the detailed description and specific examples, while indicating preferred embodiments of the disclosure, are given by way of illustration only, since various changes and modifications within the scope of the disclosure will become apparent to those skilled in the art from this detailed description.

What is claimed is:

1. A cell assembly comprising:
a first sleeve comprising:
a first side;
a second side facing the first side;
a third side connecting the first side and the second side;
a first open end between the first side and the second side;
a second open end between the first side and the second side, and opposite the first open end; and
a third open end between the first open end and the second open end and opposite the third side; and
a first pouch-type cell between the first side and the second side of the first sleeve, the first pouch-type cell comprising a first electrode tab and a second electrode tab, wherein a first surface of the first pouch-type cell is adjacent to the third open end, and wherein a second surface of the first pouch-type cell is opposite the first surface, and spaced apart from the third side of the first sleeve by a predetermined distance.

2. The cell assembly of claim 1, wherein the first pouch-type cell comprises a third surface and a fourth surface opposite the third surface, wherein the third surface of the first pouch-type cell is coupled to an inner surface of the first side of the first sleeve, and wherein the fourth surface of the first pouch-type cell is coupled to an inner surface of the second side of the sleeve.

3. The cell assembly of claim 2, further comprising an adhesive between the third surface of the first pouch-type cell and the first side of the first sleeve.

4. The cell assembly of claim 1, further comprising an adhesive member attached to an outer surface of the first side of the first sleeve.

5. The cell assembly of claim 1, wherein the first sleeve is made of stainless steel.

6. The cell assembly of claim 1, wherein the first sleeve includes a terminal on the third side of the first sleeve, and wherein the terminal is electrically coupled to the first electrode tab.

7. The cell assembly of claim 1, wherein the first surface of the first pouch-type cell comprises a sealing portion, and wherein the second surface of the first pouch-type cell comprises a non-sealing portion.

8. The cell assembly of claim 1, wherein the second surface of the first pouch-type cell comprises a sealing portion, and wherein the first surface of the first pouch-type cell comprises a non-sealing portion.

9. The cell assembly of claim 1, further comprising:
a second sleeve; and
a second pouch-type cell in the second sleeve, wherein the second pouch-type cell comprises an electrode tab.

10. The cell assembly of claim 9, wherein the first side or the second side of the first sleeve is adjacent to a side of the second sleeve.

11. The cell assembly of claim 9, wherein the first electrode tab or the second electrode tab is coupled to the electrode tab of the second pouch-type cell.

12. The cell assembly of claim 9, further comprising a connector coupled to the first sleeve and the second sleeve.

13. The cell assembly of claim 12, wherein the connector comprises a frame and a conductive portion inside the frame, and wherein the conductive portion is coupled to the first electrode tab of the first pouch-type cell and the electrode tab of the second pouch-type cell.

14. The cell assembly of claim 9, wherein the first electrode tab is a positive electrode tab of the first pouch-type cell, wherein the second electrode tab is a negative electrode tab of the first pouch-type cell, and wherein the electrode tab of the second pouch-type cell is a positive electrode tab or a negative electrode tab of the second pouch-type cell.

15. The cell assembly of claim 1, further comprising a plurality of the first pouch-type cells.

16. The cell assembly of claim 15, wherein the first electrode tab of one of the plurality of the first pouch-type cells is coupled to the first electrode tab or the second electrode tab of an adjacent one of the plurality of the first pouch-type cells.

17. The cell assembly of claim 15, further comprising:
a second sleeve;
a plurality of second pouch-type cells in the second sleeve, each of the plurality of second pouch-type cells including an electrode tab; and
a connector electrically coupling one of the first electrode tabs of the plurality of the first pouch-type cells with one of the electrode tabs of the plurality of second pouch-type cells.

18. The cell assembly of claim 1, wherein the third side of the first sleeve comprises a venting portion.

19. The cell assembly of claim 18, wherein the venting portion includes a slit or an opening.

20. The cell assembly of claim 18, wherein the third side of the first sleeve comprises a plurality of the venting portions.

21. A sleeve for a cell assembly comprising:
a first side;
a second side facing the first side;
a third side connecting the first side and the second side, the third side including a venting portion;
a first open end between the first side and the second side;
a second open end between the first side and the second side, and opposite the first open end; and
a third open end between the first open end and the second open end, and opposite the third side, wherein the sleeve is configured to accommodate a pouch-type cell between the first side and the second side of the sleeve, the pouch-type cell comprising a first electrode tab and a second electrode tab, and wherein a first surface of pouch-type cell is adjacent to the third open end, and opposite the third side of the sleeve.

22. A battery pack comprising:
a case having an inner surface;
a cell assembly on the inner surface, the cell assembly comprising:
a plurality of sleeves; and
a pouch-type cell accommodated inside each of the plurality of sleeves, the pouch-type cell comprising a first electrode tab and a second electrode tab, wherein a first surface of the first pouch-type cell is adjacent to the inner surface of the case, and wherein a second surface of the first pouch-type cell is opposite the first surface, and spaced apart from at least one surface of each of the plurality of sleeves by a predetermined distance.

23. The battery pack of claim 22, wherein each of the plurality of sleeve comprises:
a first side;
a second side opposite the first side;
a third side between the first side and the second side;
a first open end between the first side and the second side;
a second open end between the first side and the second side, and opposite the first open end; and
a third open end between the first open end and the second open end, and opposite the third side.

24. The battery pack of claim 22, wherein the first surface of the pouch-type cell is coupled to the inner surface of the battery pack.

25. The battery pack of claim 22, wherein the inner surface of the battery pack comprises a plurality of openings, wherein a portion of the first side of one of the plurality of sleeves is accommodated in one of the plurality of openings, and wherein a portion of the second side of the one of the plurality of sleeves is accommodated in another one of the plurality of the openings.

26. The battery pack of claim 22, wherein the inner surface of the battery pack comprises a heat sink.

27. The battery pack of claim 22, wherein the inner surface of the battery pack comprises a plurality of heat sinks.

28. The battery pack of claim 22, further comprising a battery management system.

29. The battery pack of claim 27, wherein a portion of the first side of each of the plurality of sleeves is accommodated between at least two of the plurality of heat sinks.

30. The battery pack of claim 22, wherein the inner surface of the battery pack comprises a thermal resin, and wherein the cell assembly is coupled to the thermal resin.

31. The battery pack of claim 22, wherein the third side of each of the plurality of sleeves is coupled to the inner surface of the battery pack.

32. A vehicle comprising the battery pack of claim 22.

33. A method of manufacturing a cell assembly, the method comprising the steps of:
providing a sleeve comprising:
a first side;
a second side facing the first side;
a third side connecting the first side and the second side;
a first open end between the first side and the second side;
a second open end between the first side and the second side, and opposite the first open end; and
a third open end between the first open end and the second open end, and opposite the third side; and
providing a pouch-type cell between the first side and the second side of the sleeve, the pouch-type cell comprising a first electrode tab and a second electrode tab, wherein a first surface of the pouch-type cell is adjacent to the third open end, and wherein a second surface of the pouch-type cell is opposite the first surface, and spaced apart from the third side of the sleeve by a predetermined distance.
